(19) United States
(12) Patent Application Publication
(10) Pub. No.: US 2026/0368837 A1
(43) Pub. Date: Nov. 19, 2026

(54) GENERATIVE AI SYSTEMS AND METHODS FOR CONTRACT RATIFICATION

(71) Applicant: Safeway Inc., Pleasanton, CA (US)

(72) Inventors: Karthik Balasubramanian, Livermore, CA (US); Sivakumar Thillaikannu, Frisco, TX (US); Avijit Majumdar, Pleasanton, CA (US); Sheila Gnanamani, Scottsdale, AZ (US)

(21) Appl. No.: 19/674,602

(22) Filed: May 12, 2026

Related U.S. Application Data
(60) Provisional application No. 63/805,439, filed on May 14, 2025.

(51) Int. Cl. G06Q 50/18; H04L 51/02

(52) U.S. Cl. CPC G06Q 50/188; H04L 51/02

(57) ABSTRACT

Disclosed herein is technology for ratifying contracts. The disclosed technology can perform operations including: receiving data about a contract that can include at least a proposal for modifying the contract, generating contract negotiation information based on processing the data about the contract, transmitting the contract negotiation information to a user device, receiving, from the user device, user input responsive to the user device presenting the contract negotiation information, ratifying one or more contract changes to the contract based on the user input and the contract negotiation information, and executing instructions to process the ratified contract changes.

### PRIORITY CLAIM

This application claims the benefit of and priority of U.S. Provisional Patent Application No. 63/805,439, filed May 14, 2025. Disclosure of the above-referenced application is incorporated herein by reference in its entirety

### TECHNICAL FIELD

This disclosure generally describes devices, systems, and methods related to a contract ratification process using trained large language models (LLMs) and, more specifically, artificial intelligence (AI) models.

### BACKGROUND

A union labor contract, also known as a collective bargaining agreement (CBA), can outline terms and conditions of employment between a company and its unionized workforce. The CBA can cover aspects including but not limited to wages, benefits, working hours, job security, and/or grievance procedures. In a traditional negotiation process, collective bargaining can occur in which employers and union representatives engage in negotiations to reach a mutually acceptable contract. Once negotiations conclude, a tentative contract can be drafted. However, this can require ratification by union members. Ratification can include a rank-and-file decision, in which union members vote on whether to accept or reject the tentative contract. This vote can be crucial because it directly affects the workforce’s conditions. Union members can also evaluate whether the contract meets their needs. They can consider factors such as wages, benefits, and/or job security. Union chapters can organize meetings and discussions to inform members about the contract details. The ratified contracts ought to strike a balance between employee welfare and business viability.

On average, hundreds of labor agreements can be ratified a year, with increased volume during mergers and/or divestiture plans. This is coupled with the backdrop of complex negotiated contractual obligations and ongoing, ever-increasing labor regulations. The traditional ratification process can take weeks to process, with complex manual interventions and laborious workflows, which can cause payroll delays.

### SUMMARY

The disclosure generally describes techniques for advanced LLMs and AI for streamlining contract ratification processes. The disclosed technology can streamline the ratification process to ensure accuracy, compliance, and efficiency across all internal and external systems. The disclosed technology can enhance productivity, reduce or otherwise eliminate human errors, and foster compliance with labor regulations to improve payroll excellence and related user experiences. The disclosed technology can reduce the contract ratification process by days, if not weeks, and provide a consistent understanding of labor rules and changes across divisions and systems. Enhanced productivity in searching and analyzing contract documents from the disclosed technology can also improve capabilities to generate labor rules from labor contracts and create a system-agnostic digital rules repository for use in labor contract agreements and other contract negotiations.

The disclosed technology can provide one or more functions and capabilities, including but not limited to contractual renewals and negotiations (e.g., CBAs, memorandums of understanding), labor relations management, user experiences, contract changes reviews and analysis, data gathering, configuration file building, quality control, human resource management and payroll configurations, validation of system loads and coexistence, human resources (HR) data updates, payroll, and retro payments, etc. The disclosed technology can therefore provide for contract ratification through AI techniques, which can provide efficiency, accuracy, risk mitigation, and scalability, making it a valuable tool to optimize contract management processes.

Generative AI (GenAI) for contract ratification can leverage software components, algorithms, and/or models to achieve advanced capabilities in natural language processing, understanding legal context, and generating coherent, context-aware text. GenAI therefore adds a layer of intelligence and automation specifically tailored for a complex and nuanced domain of legal contracts. The disclosed technology can also provide for seamlessly managing and updating many contracts at once for many different workforces. These contracts can encompass a wide range of employees, including but not limited to store workers, drivers, and logistics operators, each with specific needs and requirements. To ensure a smooth and harmonious working environment, these contracts ought to be properly negotiated, ratified, and executed. Existing systems for ratifying contracts is manual and handled using spreadsheet-based templates with no technical interface to search or query contract documents, including but not limited to collective bargaining agreements (CBAs), inter office communications (IOCs), and/or wage sheets. The CBAs can include master agreements that were first negotiated and contain terms and conditions of employment for all employees covered by the agreements. The IOCs can outline effective dates, expiration dates, and ratification dates. The wage sheet can include a spreadsheet with data regarding wage changes defined in the IOC along with current wage data.

The disclosed technology can provide for execution of a ratified contract. These techniques can provide stability in the ratification process and reduce uncertainty for all relevant parties. These techniques may also improve relations amongst the parties and ensure compliance with various standards, regulations, and/or labor-related rules.

As described herein, the disclosed technology can include ingesting contract-related data, constructing negotiation context information, distributing negotiation insights, capturing user feedback, confirming and approving contract amendments, and implementing and operationalizing contract changes. Ingesting the data can include receiving and interpreting, using AI techniques, incoming data associated with a contract, where the data can include at least a proposed amendment and/or revision to existing contractual terms. The ingested data can include an existing labor contract, which can include a text or structured elements of a current collective bargaining agreement or other employment-related contractual documents that may be subject to negotiation, modification, and/or ratification. The ingested data can include policies and procedures, which can include internal organizational policies, standard operating procedures, and/or governance documents that may inform or constrain terms of the contract. These documents may further define work rules, compliance obligations, disciplinary processes, and/or organizational standards that can be referenced in the contract. The ingested data can include HR data, which may include workforce demographics, wage and benefit structures, job classifications, employment history, performance metrics, and/or compensation benchmarks. This data can provide contextual insight into how proposed contract changes may impact employees and/or organizational practices.

Constructing the negotiation context information can include analyzing and processing, using the AI techniques, the received contract data to generate relevant negotiation materials or context, including but not limited to suggested terms, legal implications, version comparisons, and/or risk evaluations. Distributing the negotiation insights can include communicating and/or delivering the generated negotiation context information to authorized user devices, thereby facilitating user review, collaboration, and/or further negotiations. Capturing the user feedback can include collecting user-generated input from the authorized user devices in response to the presented negotiation context information. This can include user review, collaboration, and/or further negotiation. Confirming and approving contract amendments can be based on the user feedback and the negotiation context information. The confirming can include validating and finalizing specific changes to the contract, such as effectively formalizing and/or ratifying the modifications. Implementing and operationalizing contract changes can include executing instructions to apply the ratified amendments/modifications within an overall enterprise system. This can include updating internal systems, triggering downstream workflows, storing audit logs, and/or notifying relevant stakeholders.

The AI techniques described herein can be trained to identify potential conflicts, compliance risks, and/or optimization opportunities, and formulate counter proposals to address such issues while aligning with organizational goals, legal constraints, and/or strategic negotiation outcomes. The counter proposals may include but are not limited to alternative clauses, suggested amendments, conditional acceptances, and/or escalation pathways. The counter proposals can be presented to the relevant stakeholders or other users through graphical user interfaces (GUIs) and/or a chatbot for review, implementation, and/or further negotiation. The GUIs can also present selectable features that allow a user to upload contract documents, initiate processing of the documents using the disclosed AI, and/or extract structured outputs from the AI In the form of standardized templates, which may include but is not limited to proposed terms, key risks, financial models, and/or decision-ready summaries for negotiation and/or review. The chatbot interface can be responsive, allowing a user to engage in a dialogue, ask clarifying questions, and receive dynamic, real-time responses from the AI. More particularly, the disclosed technology can enhance contract negotiation by integrating the chatbot within the GUIs. The disclosed technology can transmit instructions to display the chatbot, receive user queries, and/or route them to the AI techniques that are trained to generate relevant contract negotiation insights. The AI techniques can process these inputs and return context-aware responses, such as implementation scenarios, cost models, and/or risk assessments, which can then be displayed within the chatbot to enable real-time interactive contract discussions. Sometimes, user inputs in the chatbot can include metadata, which can be used by the AI techniques to better understand context and scope of the user’s query. This can result in the AI techniques determining and generating more precise and contextually relevant responses to the specific query.

The AI techniques can further be trained to process and compare historical contract data and proposed modifications to contracts. Rather than performing a direct deterministic search, the AI techniques can be configured to utilize contextual inputs and structured prompts to a large language model (LLM), which can synthesize potential counter proposals based on patterns, prior negotiations, and/or domain-specific heuristics.

In some implementations, the AI techniques can be configured to generate summaries of a proposal to offer stakeholders a holistic view of the contract modification process, thereby making it easier to evaluate the full scope and impact of proposed changes before ratifying the contract with the modifications. The summary can be presented as a dynamic, user-friendly report, allowing for real-time review and decision-making by the relevant stakeholders. The summary can be generated by the AI techniques in a human-readable format, with the ability to extract actionable insights from both structured and unstructured data sources. Sometimes, the summary can be provided as an interactive report that users can download, review, modify, and/or use as a basis for further negotiations.

In some implementations, the AI techniques can generate IOCs based on the contract changes. The IOCs can be formatted for internal distribution and can be delivered through various communication channels ensuring that all relevant stakeholders are informed of the contract ratification process and aligned on next steps in the process. Sometimes, the AI techniques can generate or update a wage sheet to ease formatting and keep a consistent structure across all divisions in an enterprise. The AI techniques can also be used to redline an existing contract, which can enable enhanced collaboration, transparency, and auditability throughout the contract negotiation and ratification process while also ensuring consistency and legal integrity in the contract language. Sometimes, the AI techniques can generate a field operational manual based on processing structured and unstructured data from an original contract, ratified changes to the contract, and relevant enterprise policy documentation, thereby enabling seamless transition from agreement to execution. Similarly, the AI techniques can generate configuration templates, which can accelerate implementation of the modified contract and reduce manual error during contract ratification. The AI techniques can generate pay templates to standardize and streamline the evaluation and generation of compensation terms in contract proposals. When used with the AI, the pay templates allow for rapid simulation of pay scenarios, consistent application of policy and/or contractual standards, and/or seamless integration into downstream systems for payroll and/or financial planning once the contract is ratified.

Determinations made by the AI techniques can also be provided to downstream systems in an enterprise. For example, the AI outputs can be transmitted to HR systems and other systems that interact with contractual terms. By automating the transfer and implementation of ratified contract changes, the disclosed technology can ensure that the enterprise swiftly and accurately reflects the new contract terms across all relevant processes, thereby minimizing risk of errors and/or delays in implementation.

One or more embodiments described herein can include a system for ratifying a contract, the system including: processors and memory storing instructions that, when executed, can cause the processors to perform operations that may include: receiving data about a contract, the data including at least a proposal for modifying the contract, generating contract negotiation information based on processing the data about the contract, transmitting the contract negotiation information to a user device, receiving, from the user device, user input responsive to the user device presenting the contract negotiation information, ratifying one or more contract changes to the contract based on the user input and the contract negotiation information, and executing instructions to process the ratified contract changes.

In some implementations, the embodiments described herein can optionally include one or more of the following features. For example, generating the contract negotiation information can include analyzing, using artificial intelligence (AI), the data about the contract. Generating the contract negotiation information can include generating one or more counters to the proposal for modifying the contract based on analyzing (i) the data about the contract and (ii) the contract negotiation information. The counters to the proposal for modifying the contract can be generated by an AI system that may be trained to process and compare historic data about the contract and the proposal for modifying the contract.

Sometimes, generating the contract negotiation information can include: receiving user input about the proposal for modifying the contract in a chatbot presented at the user device, providing the user input about the proposal for modifying the contract to an AI system, the AI system having been trained to generate (i) contract implementation scenarios based on processing the user input about the proposal for modifying the contract and the data about the contract and (ii) cost models based on processing the contract implementation scenarios, and receiving, as output from the AI system, the contract implementation scenarios and the cost models as the contract negotiation information. As another example, generating the contract negotiation information further can include generating, using the AI system, a summary of the proposal for modifying the contract, the contract implementation scenarios, and the cost models.

In some implementations, the data about the contract can be received from a group of disparate data sources that can be in network communication with the system. Ratifying the one or more contract changes can include generating, using an AI system, an inter office communication (IOC) based on the one or more contract changes. Ratifying the one or more contract changes can include updating, using an AI system, a wage sheet based on the one or more contract changes. Ratifying the one or more contract changes can include: comparing, using an AI system, the one or more contract changes with existing clauses in the contract, and generating, using the AI system, a revised version of the contract based on the comparison.

As yet another example, generating the revised version of the contract can include redlining, by the AI system, the contract with the one or more contract changes. Ratifying the one or more contract changes can include generating, using an AI system, a field operational manual based on the one or more contract changes. Ratifying the one or more contract changes can include generating, using an AI system, configuration templates for ratification based on the one or more contract changes. The configuration templates can sometimes include pay templates. The data about the contract further can include at least one of an existing labor contract, policies and procedures, HR data, and industry data. Sometimes, the generating and the ratifying can be performed using an AI system that can be automatically deployed at the system. The AI system can include a generative AI platform. In some implementations, transmitting the contract negotiation information to the user device can include instructions for presenting the contract negotiation information in a chatbot that can be presented in a graphical user interface (GUI) at the user device.

Sometimes, the operations can include: transmitting, to the user device, instructions to cause the user device to present a chatbot in a GUI at the user device, receiving, responsive to the user device presenting the chatbot in the GUI based on executing the instructions, user input including a query, providing the query as input to an AI system that can be trained to generate the contract negotiation information based on processing the input, receiving, as output from the AI system, a response to the query, the response including at least a portion of the contract negotiation information, and returning, to the user device, second instructions to cause the user device to update the chatbot in the GUI to include the response. The user input having the query further can include metadata associated with the contract. Sometimes, the AI system can be further configured to: process the metadata to identify the contract, retrieve, from one or more data sources, the data about the contract based on identifying the contract, and generate the response based on processing the user input and the retrieved data about the contract. As another example, executing the instructions to process the ratified contract changes can include transmitting the ratified contract changes to a downstream system that can be configured to, based on receiving the ratified contract changes, implement the ratified contract changes in an enterprise environment.

The devices, system, and techniques described herein may provide one or more of the following advantages. For example, existing systems require manual contract drafting and review. Drafting labor contracts manually is time-consuming and prone to human error. Reviewing and revising contracts can also take significant effort. Researching past ratifications and negotiation rounds adds to the workload and increases chances of human error in the process. Manual negotiations are also time-consuming due to scheduling and data analysis. Distilling complex contractual terms and language for diverse stakeholders can also present challenges while further delaying an overall contract ratification process and payroll. The disclosed technology, on the other hand, provides technical solutions to existing systems that are not technical in order to automate and improve the contract ratification process. The disclosed technology can reduce or otherwise eliminate human error, improve efficiency, and also improve user experiences.

The disclosed technology provides technical solutions through automated and seamless integration of computing systems and services that, traditionally, were siloed and only accessible by relevant human stakeholders. Said integration can allow for timely and AI-driven execution of the contract ratification process. Contracts can be very specific to particular needs and workforces (e.g., CBAs can have certain terms that are finetuned to a particular workforce). Retrieval, analysis, and synthesis of the particular data needed for these contracts are not supported by the existing systems since they do not offer integration of different data and computing systems. The disclosed technology provides technical solutions through the use of GenAI that can extract key labor rules and/or policies from repositories of mass amounts of data then intelligently merge the extracted data to generate insights and updates to existing contracts and related documentation and labor practices. The disclosed technology also provides technical solutions through an AI-based chatbot that relevant stakeholders can interact with to search across contracts, understand ratification changes, and cause changes to be made.

Moreover the disclosed technology provides for generating highly customized and personalized labor contracts and other types of contracts, especially based on input criteria from relevant stakeholders. This level of customization saves time and other technical and workforce-based resources while ensuring that contracts meet the specific needs of each relevant stakeholder. The disclosed technology further provides training and implementation of advanced natural language processing (NLP) models in order to produce contextually relevant and coherent contract text – none of which is capable with the existing non-automated systems that rely on human actions.

The disclosed technology can also provide user-friendly interfaces that simplify processes for inputting contract criteria, receiving generated contracts, and gleaning insights into existing and future contracts. The ease of use makes the disclosed system accessible to any relevant stakeholders. Relevant information and data can be displayed using graphical user interfaces (GUIs) at computing devices of the relevant users in a unique and easy way to understand format. The existing systems may not provide the disclosed solutions for at least the following reasons: (i) the significant processing power required for to receive and intelligently process many disparate data types and data points, (ii) the considerable data storage requirements for maintaining information collected and determined by the disclosed technology, and/or (iii) algorithms, AI, and/or machine learning techniques that allow for the data to be processed, analyzed, and used to generate and/or ratify contracts. In addition, the GUIs display results of the execution of these complex algorithms, AI, and/or machine learning techniques in a manner that can be easily understandable by a human user, sometimes by viewing such results on a small or handheld screen, to improve operation of computing devices, etc. Translation of outcomes from these complex algorithms, AI, and/or machine learning techniques through the GUIs displayed for a user improves comprehension of considerable quantities of highly processed data and disparate data types.

The use of AI and other modeling techniques allows for the disclosed technology to dynamically adapt to changes in labor laws, regulations, standards, and/or other guidance. This can ensure that contracts generated using the disclosed technology remain up-to-date and compliant, offering a proactive approach to compliance. Therefore, the disclosed technology ensures compliance and transparency by providing audit trails and feedback mechanisms for the contract ratification process.

As indicated above, the disclosed technology provides seamless integration with existing, siloed computing systems, databases, and/or other systems. As a result, the disclosed technology enhances workflow efficiency and creates pipelines for relevant data in contract negotiations to be shared, analyzed, and leveraged, which is not possible with the existing siloed systems. Moreover, the disclosed technology implements robust security measures to protect any sensitive data that now may flow through the integrated systems, including but not limited to encryption, secure data storage, and compliance with data protection standards and guidelines. With integration and robust security measures, the disclosed technology can also scale for enterprise-level use, thereby accommodating contract generation needs of large entities with diverse workforce requirements.

As described herein, the disclosed technology integrates GenAI with existing systems to provide for the processing and analysis of unstructured data and structured data, which cannot possibly be performed in the human mind, nor could be performed with the existing systems. The use of complex and uniquely trained models and/or AI in the disclosed technology not only provides technical solutions to the existing systems, but also reduces processing time and improves consumption of available resources. The specific operations that the disclosed models and/or AI are trained to perform, the iterative and real-time execution of said models and/or AI to generate reliable and accurate results, and the receipt and processing of many disparate types of data all in real-time or near real-time cannot be performed in the human mind nor possible with the existing systems.

Similarly, the disclosed techniques provide efficient model and/or AI training that does not require human intervention or input, which makes it impossible for this technology to be reasonably performed in the human mind. One of the purposes of this technology is to eliminate the need of human review, which can be riddled with errors, slow to generate, and/or not updated in real-time to reflect hundreds to thousands of possible variations in contract features and changes. Automating the contract ratification process eliminates the need of human intervention, and allows for quick and iterative training of models and/or AI as well as runtime use for quick and accurate contract negotiations and ratifications.

The scalability of the disclosed technology provides for an increased volume of contracts to be reviewed, modified, and ratified in less time. The disclosed technology also provides for automation of contract drafting, since it can automate the drafting of contracts, generation of preliminary contract documents based on input criteria, and reduce or eliminate manual efforts in generating contracts. Leveraging NLP capabilities can also improve precision and accuracy of contract language interpretation, thereby reducing errors or misinterpretations in contract terms. Leveraging natural language generation (NLG) can also enable the quick, efficient, and accurate generation of human-like and contextually relevant text, which goes beyond simple data processing by allowing the disclosed technology to create complex documents with coherent language and structure. Moreover, the disclosed technology leverages adaptive learning through GenAI and other machine learning components to learn from user feedback and adapt over time. This adaptive learning allows the disclosed technology to continuously improve its language generation capabilities based on real-world usage, going beyond static data storage and the existing systems.

As another example, the disclosed AI and/or models can be tuned with high sensitivity to capture and reduce false negatives and result in verified results that link to particular contract documentation and/or source data for improved explainability. AI and/or model integrity can further be improved using feedback loops to reduce hallucination and improve training.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of a system that is configured to perform an AI-enabled contract ratification process.

FIG. 2 is a flowchart of a process for preparing for a contract negotiation using AI techniques.

FIG. 3 is a flowchart of a process for analyzing contract proposals using AI techniques.

FIG. 4 is a flowchart of a process for ratifying contract changes using AI techniques.

FIG. 5 is a flowchart of a process for executing ratified contract changes.

FIG. 6 is a conceptual diagram of operations that can be performed using the AI techniques described herein.

FIG. 7 is a conceptual diagram of a system for performing an AI-enabled contract ratification process.

FIG. 8 is a conceptual diagram of a process for training one or more AI models that can be used to perform the disclosed techniques.

FIG. 9 is a system diagram of components that can be used to perform the disclosed techniques.

FIGS. 10A and 10B is a flowchart of a process for training AI models that can be used in a contract ratification process.

FIGS. 11A, 11B. and 11C, illustrate example GUIs that can be presented at a user device for performing a contract ratification process.

FIG. 12 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to techniques for automated contract negotiation and ratification through the use of complexly and uniquely trained AI and/or machine learning techniques.

In this disclosure, GenAI refers to a class of AI techniques that focus on creating new content rather than just analyzing existing data. Said techniques enable machines to generate new outputs, such as text, images, music, and/or code, based on patterns learned from training data. GenAI models can learn from large datasets of different types of data to understand patterns and features. In some implementations, said models can leverage neural networks (NNs) to capture complex relationships and generate new data that aligns with learned patterns and relationships. GenAI can be implemented as described herein to enhance customer experiences, automate content (e.g., contract) creation, and optimize processes in enterprises, such as a contract ratification process. GenAI is merely an illustrative example of modeling that can be deployed and leveraged with the disclosed technology. Other forms and types of AI and/or machine learning can also be used with the disclosed technology.

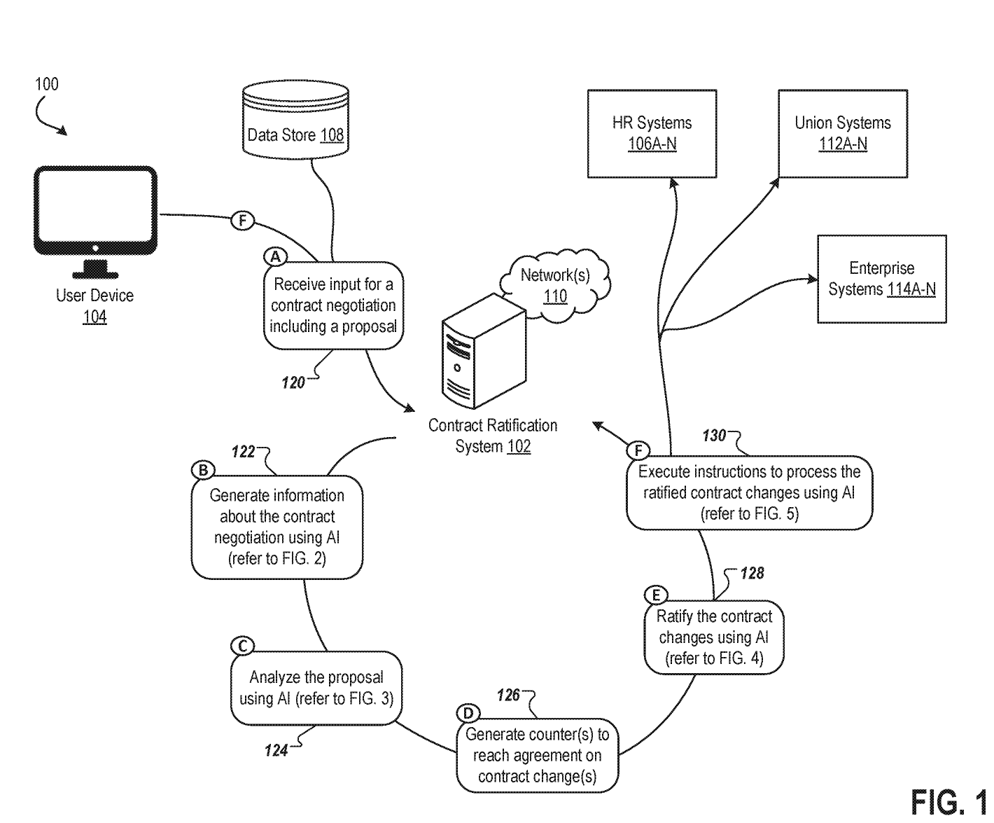

Referring to the figures, FIG. 1 is a conceptual diagram of a system 100 that is configured to perform an AI-enabled contract ratification process. The system 100 can be used to renew a current or existing contract. The system 100 can be used to modify or amend portions of a current or existing contract. In some implementations, the system 100 can be used for undergoing a negotiation process for a new contract.

The system 100 can include a contract ratification system 102 in communication (e.g., wired, wireless) via network(s) 110 with a user device 104, a data store 108, HR systems 106A-N, union systems 112A-N, and/or enterprise systems 114A-N. In brief, the contract ratification system 102 can be configured to perform the disclosed techniques of analyzing, processing, changing, and/or ratifying contracts, including but not limited to labor contracts. The user device 104 can be a computing device, mobile phone, smartphone, laptop, tablet, etc. that can be used by relevant stakeholders to a contract, such as HR, union members, and/or other members of a workforce. The data store 108 can include a data lake, data repository, and/or cloud-based storage system configured to maintain structured data, unstructured data, internal data, and/or external data described herein. The HR systems 106A-N can include computing systems that can be operated by HR in an enterprise and configured to generate and maintain information about HR and other aspects of a workforce and/or payroll. The union systems 112A-N can include computing systems that can be operated by relevant external stakeholders in a union workforce and configured to generate and maintain information about the union and other aspects of the union’s workforce. The enterprise systems 114A-N can include computing systems that can be operated by relevant employees or other stakeholders in an enterprise and configured to generate and maintain information about the enterprise and their workforce. In some implementations, one or more of the contract ratification system 102, the user device 104, the data store 108, the HR systems 106A-N, the union systems 112A-N, and/or the enterprise systems 114A-N can be integrated into one or more computing systems and/or cloud-based systems.

In the system 100, the contract ratification system 102 can receive input for a contract negotiation, including a proposal (block A, 120). Receiving the input can also include polling the data store 108, the HR systems 106A-N, the union systems 112A-N, and/or the enterprise systems 114A-N for relevant data (e.g., structured data, unstructured data, internal data, external data) described further below. The input can include but is not limited to data relating to business environment, wage, jobs, labor contracts, labor cost, surveys, health plans, pension plans, labor market, and/or industries.

The contract ratification system 102 can generate information about the contract negotiations using AI techniques described herein (block B, 122). Refer to FIG. 2 for further discussion. Generating the information can include processing the received input data using AI techniques, such as GenAI and/or other explainable AI and/or models. The AI techniques can be leveraged to analyze current contracts (e.g., a current contract undergoing renewal, a current contract undergoing amendments or other modifications during a contract negotiation, a current contract that can be used as a basis or comparison for a new contract negotiation) for one or more issues that may need to be corrected or otherwise changed during the contract negotiation. For example, the AI techniques can include models that are trained to identify language issues (e.g., management rights, no strike language, past practices language, bargaining duty languages), and/or operating issues (e.g., operational hours rights/limitations, scheduling flexibility/limitations, work assignment rights/limitations, subcontracting/vendor work, technology rights/limitations, worker safety/loss prevention issues, temporary alternative duty restrictions). Generating the information can also include leveraging the AI techniques to analyze other labor contracts in same or similar areas for advantages and disadvantages that may be mapped onto the existing contract and/or contract proposal. The AI techniques may be additionally or alternatively used to analyze past grievances and arbitrations, to identify whether any adverse decisions may also require change, and/or to determine whether past practices that were contractual, mutual, and/or unilateral may also require change. In some implementations, the disclosed AI techniques can be used to analyze relevant user surveys and comments that may identify relevant issues in the existing contract. Health plans may also be reviewed in series or in parallel by using the disclosed AI techniques to identify best practices, benefits plan designs, changes during previous contracts, contemplated changes, funding status, contributions, and/or eligibility requirements. Similarly, the disclosed technology can be used to analyze pension plans and plan contract changes accordingly.

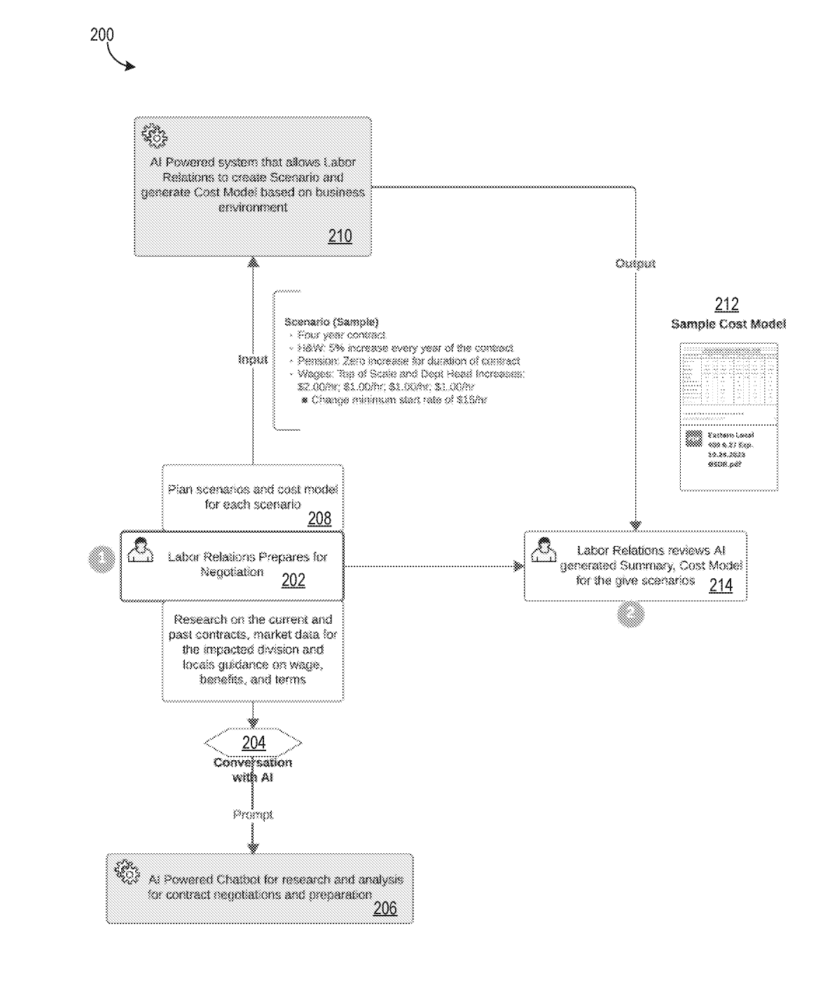

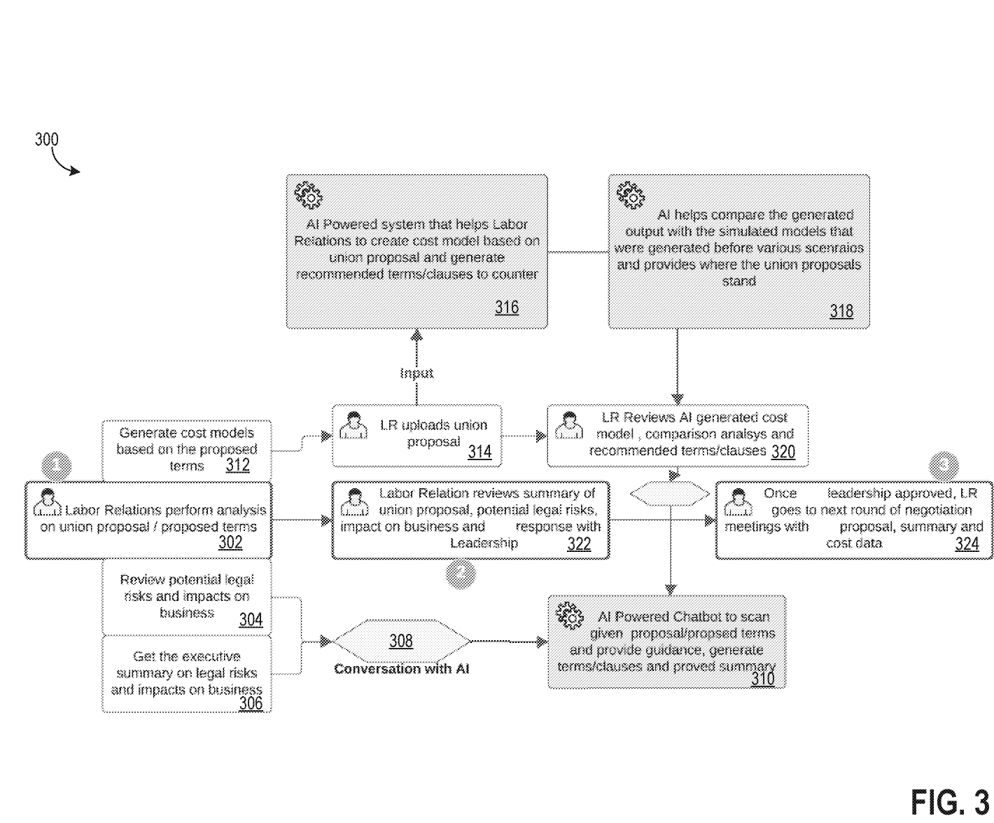

The contract ratification system 102 can also analyze the proposal using AI techniques described herein in block C (124). Refer to FIG. 3 for further discussion. In some implementations, the system 102 can use the trained AI techniques to provide initial and/or updated proposals based on history, financial data, cost models, market/industry data, existing templates, guidelines and /or regulations, and/or other data described herein.

In block D (126), the system 102 can generate one or more counters to reach agreement on contract changes. The system 102 can leverage the described AI techniques to generate new content to support the ratification process. As merely illustrative examples, the disclosed technology can be used to generate labor costing models and models to review with relevant stakeholders in the enterprise. GenAI and/or other types of explainable AI may be used to further generate summaries and/or detailed reports on the proposal, which can be reviewed and used at the negotiating table. The system 102 can also formalize and finalize the proposal by automatically generating coherent clauses based on existing templates and data repositories of information. The AI techniques described herein can be trained to analyze data such as market data and recommend competitive wage and benefit terms for the contract negotiation. The disclosed AI techniques can also be trained to determine and propose flexible scheduling language and other provisions that align with local standards, guidelines, and/or practices.

As described herein, the disclosed AI techniques can be trained to review union-proposed terms, automatically perform data analysis, and provide guidance on contract language and changes accordingly, without human intervention. The AI techniques can further be leveraged to identify potential risks with contract changes and/or existing contract terms and provide recommendations to the relevant stakeholders regarding those risks and how to work around the risks.

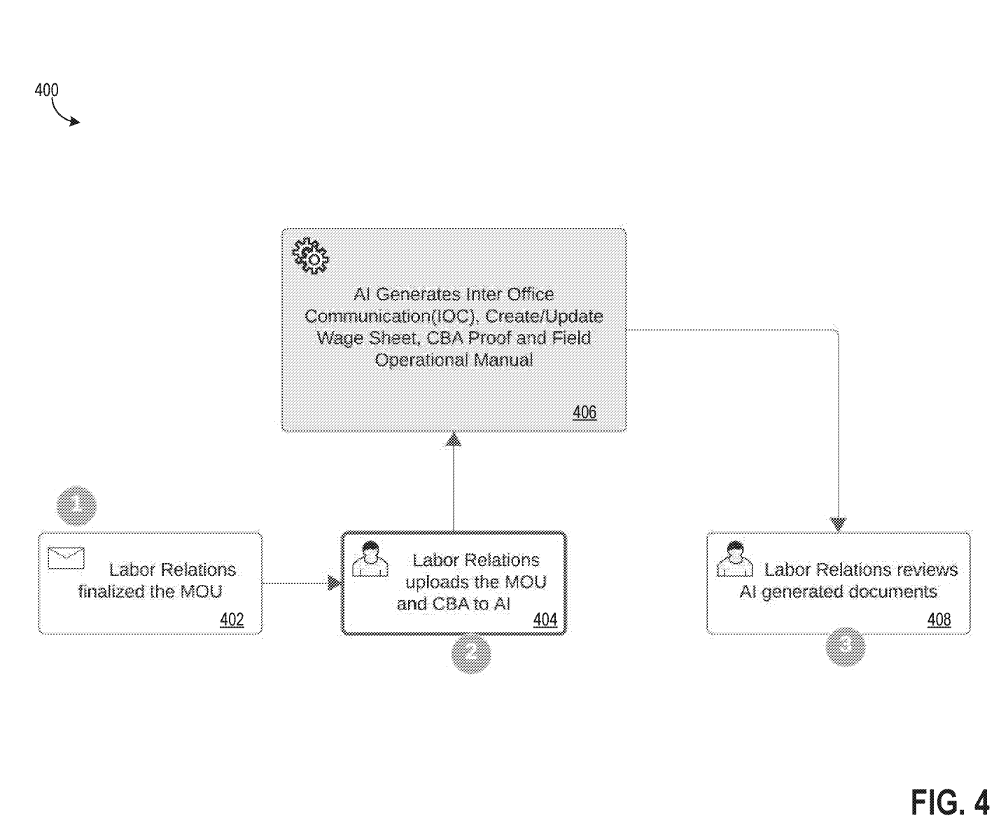

The system 102 can also ratify the contract changes using AI techniques described herein (block E, 128). Refer to FIG. 4 for further discussion. Once the contract is signed by the relevant stakeholders, the ratified changes need to be updated in existing systems. Streamlining said updates can require additional supporting documents to outline the changes (e.g., both number changes and language changes), which the disclosed AI techniques can automatically generate. For example, the AI techniques can be trained to extract ratified changes from documents and produce IOCs with information needed to process the changes, either automatically and/or semi-automatically. Moreover, the AI techniques can be trained to calculate and update wage structures and/or progression steps based on the ratified changes, all of which can be presented in AI-generated documents to the relevant stakeholders without requiring human intervention and error-prone calculations. As another example, the AI techniques can be trained to review the original CBA and perform any necessary redlines and/or updates based on the ratified changes, again reducing overhead costs and time that traditionally would occur when humans review and update said agreements. In some implementations, the AI techniques can be trained to review retail operations manuals, extract important terms, analyze against the ratified changes, and combine such analysis with the updated CBA to automatically generation operational manuals for retail associates and other relevant stakeholders. Similarly, the AI techniques can be trained to generate explainable summaries of tentative agreements and ratified agreements/changes for ingestion by different types of systems and stakeholders associated with the enterprise (e.g., corporate finance, senior leadership, retail associates, union workforce members).

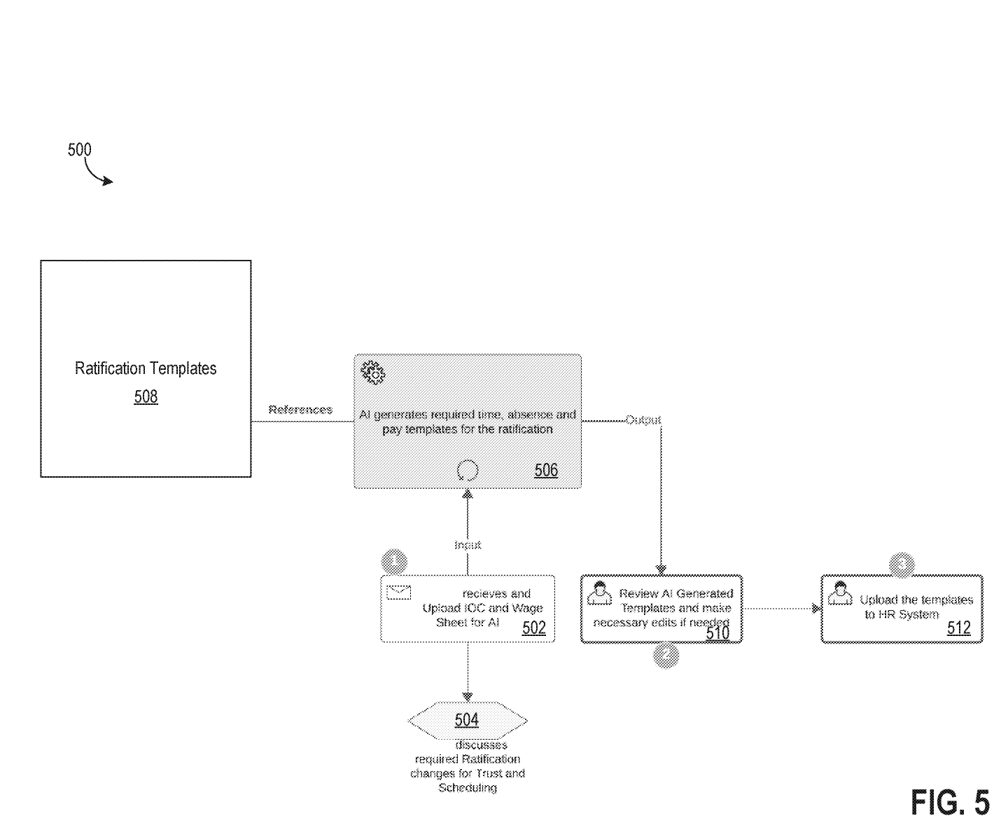

In block F (130), the system 102 can execute instructions to process the ratified contract changes using AI techniques described herein. Refer to FIG. 5 for further discussion. Executing the instructions can include transmitting information and/or instructions to be executed at the HR systems 106A-N, the union systems 112A-N, the enterprise systems 114A-N, and/or the user device 104. Sometimes, executing the instructions can include automatically configuring or reconfiguring the HR systems 106A-N. The AI techniques can be trained to generate configuration templates for the HR systems 106A-N relating to time, pay, and/or absence to ensure smooth implementation of the ratified changes. The AI techniques described herein can also be trained to generate various other templates to ensure that the changes and associated retro pay can be calculated and paid appropriately. The other templates can include but are not limited to labor agreements, employee category, scheduled events, job codes, facility information, valid codes by department, salary step components, grade and wage progression, manage rates, slim mapping, relief, and pay rates, and/or time, pay, and/or absence management. Various other templates may also be generated using explainable AI techniques described herein.

FIG. 2 is a flowchart of a process 200 for preparing for a contract negotiation using AI techniques. One or more blocks in the process 200 can be performed by the contract ratification system 102 described herein. In some implementations, one or more blocks in the process 200 can be performed by other computing systems, cloud-based systems, and/or software modules. For illustrative purposes, the process 200 is described from the perspective of a computer system.

Referring to the process 200 in FIG. 2, labor relations can prepare for contract negotiation in block 202. For example, relevant users can launch and converse with an AI chatbot provided by the computer system at their user device(s) (block 204). The users can provide input into the AI chatbot to research on current and past contracts, market data for impacted divisions and local guidance on wages, benefits, and terms. The AI chatbot can be trained to receive the user inputs and analyze the contract negotiation and preparation based on the user inputs (block 206). Based on outputs from the AI chatbot, the user can generate and plan scenarios and/or one or more cost models for potential scenarios (block 208). The computer system can be configured to retrieve and analyze historic data associated with prior labor negotiations, economic climate data, and/or enterprise financials, among other data types described herein.

The scenarios can be generated and planned using AI techniques deployed at the computer system. For example, the computer system can leverage the AI techniques described herein in block 210 to generate accurate scenarios and cost models based on various data (data provided by the user(s) and/or data retrieved from integrated systems). The computer system can implement AI models that were trained to generate and simulate one or more different potential scenarios of the contract negotiation. The AI can include LLMs that were or are trained using preprocessed data, including but not limited to historical negotiation transcripts, legal documents, industry specific data, and/or other company data. The AI can be trained using supervised learning techniques in order to teach the AI specific types of negotiation strategies and/or outcomes. The AI can further be trained to simulate hypothetical scenarios to predict potential responses and outcomes of various different contracts terms and/or revisions.

The AI models can simulate different scenarios for achieving an optimal sample cost model that balances various factors (e.g., union fees due, pension, healthcare costs). As a result, the computer system can also generate different cost models as outputs based on the different inputs provided from the user. The AI can return a cost model per scenario as output. Sometimes, the AI can also generate, as output, executive summaries for each cost model per scenario. For example, the AI models can be used to create 3-4 scenarios, such as an increase in wages, an increase in pension, and/or an increase in healthcare coverage. In this illustrative example, the AI can generate a first scenario with a 4 year contract, with zero increase in health and welfare for the duration of the contract, a pension having a zero increase for the contract duration, and top of scale and department head wage increases of $1.50/hour and $0.75/hour. In this illustrative example, the AI can generate a second scenario with a 4 year contract, 5% increase every year of the contract in health and welfare, zero increase in pension for the duration of the contract, and top of scale and department head wage increases of $2.00/hour and $1.00/hour. In this example, the AI can generate an nth scenario with a 4 year contract, 5% increase every year of the contract in health and welfare, zero increase in pension for the duration of the contract, and top of scale and department head wage increases of $2.00/hour and $1.00/hour, where a change in minimum start rate is $15/hour. Various other scenarios may also be generated by the disclosed AI and in light of contract proposals that are provided as inputs to the AI.

As described further herein, the computer system can also compare union proposals against the simulated scenarios to determine whether the union proposals fall within a threshold acceptable range associated with the scenarios. If the computer system determines that the union proposals fall outside of the threshold acceptable range associated with any one or more of the scenarios, the computer system can generate recommendations for counters that can be brought to the negotiating table. For example, the AI models can generate output indicating suggestions for contract conditions, which a relevant user can select, modify, and/or otherwise incorporate into their negotiations.

The computer system can train the AI models described above as GenAI models. As part of the training, the computer system can feed current enterprise activities into the models and provide indications of desired output as training data. The models can train on said data to determine and generate desired outputs/outcomes, such as scenarios and/or sample cost models.

The computer system can generate output, such as a sample cost model (block 212), which can be provided to the user(s) at their user devices for review (block 214). The computer system can generate one or more sample cost models for each simulated scenario. In some implementations, the user(s) can provide additional feedback as input to the computer system to regenerate and/or tweak the scenarios and/or estimated cost models (block 210). This iterative process can continue until the user(s) determines that a suitable sample cost model output (or multiple sample cost model outputs) in block 212 are generated for the particular negotiation. In some implementations, the feedback from the user(s) can be used by the computer system to finetune the AI models and/or other techniques that are used in the process 200 of FIG. 2.

In addition to generating the sample cost model as output in block 212, the computer system can generate summaries, reports, and/or other information about the potential scenarios regarding the contract negotiation. Explainable AI techniques can be trained and used to generate said documentation, which can distill thousands of disparate data points having different data types into a coherent, understandable, human format.

FIG. 3 is a flowchart of a process 300 for analyzing contract proposals using AI techniques. The process 300 can be performed after performing the process 200 for contract negotiation preparation. One or more blocks in the process 300 can be performed by the contract ratification system 102 described herein. In some implementation, one or more blocks in the process 300 can be performed by other computing systems, cloud-based systems, and/or software modules. For illustrative purposes, the process 300 is described from the perspective of a computer system.

The process 300 can begin by performing an analysis of a union proposal and/or proposed terms to a contract in block 302. For example, labor relations or other relevant users can interact with an AI chatbot described herein (block 308) to review and analyze potential legal or other risks and impacts of the proposal/terms on an enterprise business (block 304). The relevant users can interact with the AI chatbot to obtain AI-generated executive summaries of said impacts and/or risks (block 306). The AI chatbot, which can be provided by the computer system, can be trained to analyze a user-provided proposal and/or proposed terms to generate recommendations/guidance, proposed terms/clauses, and/or summaries (block 310). The relevant users may also provide input at their user device(s) to interact with the computer system as described in the process 200 of FIG. 2 to generate cost models based on the proposed terms (block 312).

The labor relations or other relevant stakeholders can also provide input at their device by uploading the union proposal/proposed terms (block 314), which can be ingested into a data pipeline at the computer system. The computer system can process this input to generate the cost models and/or one or more recommendations for updated terms and/or clauses to counter the union proposal (block 316). As described with respect to the process 200 of FIG. 2, the computer system can leverage trained AI models to generate the cost models, which can be used to identify potential increases or other changes to the contract that may be provided via the union proposal. The cost models and recommendations can be provided back to the user devices for review by the relevant users (block 320).

Before, during, or after performing block 320, the computer system can also leverage the AI techniques described herein to compare the generated cost models with simulated models generated of past and present scenarios (refer to the process 200 of FIG. 2) (block 318). As a result, the computer system can perform an automated analysis of the cost models to assist the relevant users in determining appropriate clauses and/or terms to bring to the negotiating table in response to the union proposal.

The relevant users can also interact with the computer system described herein to review a summary of the union proposal (which can be generated automatically using the AI techniques described), potential risks, impact on the business, and other information that may be gathered and analyzed by the AI chatbot and/or other AI techniques of the computer system (block 322). In some implementations, block 322 can be performed in parallel with one or more of blocks 314, 316, 318, and/or 320. Sometimes, block 322 can be performed in a feedback look with the blocks 314, 316, 318, 320, or any combination thereof.

The relevant users and leadership can receive and review all the determinations and information that was generated/provided by the computer system in block 324 to approve terms/clauses that can be presented in response to the union proposal. In other words, the AI techniques and models described herein can output information for the users about the comparison analysis. The AI techniques can generate output such as options regarding contract terms and/or updates that may match the union proposal and/or counter/deviate from the proposal. For example, the AI techniques can generate output such as changes to terms and/or clauses and other recommendations for countering the union proposal and/or supporting the enterprise operations.

In some implementations, block 324 can be performed in parallel with one or more of blocks 314, 316, 318, 320, and/or 322. Sometimes, block 324 can be performed in a feedback look with the blocks 314, 316, 318, 320, 322, or any combination thereof.

FIG. 4 is a flowchart of a process 400 for ratifying contract changes using AI techniques. The process 400 can be performed in response to performing the process 300 in FIG. 3. One or more blocks in the process 400 can be performed by the contract ratification system 102 described herein. In some implementation, one or more blocks in the process 400 can be performed by other computing systems, cloud-based systems, and/or software modules. For illustrative purposes, the process 400 is described from the perspective of a computer system.

In the process 400, a memorandum of understanding (MoU) can be generated and/or finalized in block 402. The MoU can be generated by the disclosed AI techniques of the computer system, in some implementations. A relevant user, such as labor relations, can provide input in one or more GUIs at their user device that includes documents relating to the contract negotiation (e.g., agreed upon terms/conditions) (block 404). Said documents can include but are not limited to the MOU and/or the CBA.

The inputs can be provided to the computer system via a data pipeline and provided as inputs to the AI techniques described herein. The AI techniques can be trained to automatically generate IOCs, create and/or update wage proofs, create and/or update CBA proofs and/or field operational manuals, and/or generate other relevant documentation for ratifying the contract changes (block 406). For example, the AI models described herein can be trained with NLP techniques to redline modified terms onto the CBA, merge documents such as the CBA and CBA proof(s), generate IOCs, generate wage sheets and/or progression rates, and/or generate the manuals used by users in the field so that they can easily understand and deploy changes that are occurring in the field as a result of the contract negotiation and ratification process.

The computer system can provide the generated documentation to the user device for presentation in one or more GUIs therein such that the relevant users can review the documents (block 408). In some implementations, block 408 can have a feedback loop back to block 406, in which additional user input can be provided to modify any of the AI-generated documents. The AI techniques described herein can also be iteratively trained based on the feedback loop and the additional user input to improve accuracy in generating the documentation.

FIG. 5 is a flowchart of a process 500 for executing ratified contract changes. The process 500 can be performed in response to performing the process 400 of FIG. 4. One or more blocks in the process 500 can be performed by the contract ratification system 102 described herein. In some implementation, one or more blocks in the process 500 can be performed by other computing systems, cloud-based systems, and/or software modules. For illustrative purposes, the process 500 is described from the perspective of a computer system.

Referring to the process 500 of FIG. 5, a relevant user can upload AI-generated documentation from the process 400 of FIG. 4 (e.g., IOC, wage sheet) using GUIs presented at a user device (block 502). In some implementations, the documentation can be automatically uploaded or otherwise available at the computer system. By uploading the documentation, the documentation can be provided to the computer system, which can receive the documentation as input to its AI techniques and generate time, absence, and/or pay templates for the ratification (block 506). Sometimes, the relevant user can provide information about trust and scheduling changes that may be required or preferred for the contract (block 504). Said information can also be provided to the computer system as input to the AI.

More generally, the AI models described herein can be trained to generate various different types of ratification templates that can be used to update systems of the enterprise, including but not limited to a payroll system. Sometimes, a relevant user can select one or more templates of preference using the GUIs. The user selection can be provided to the computer system and used as an input by the AI models to generate the appropriate templates. The AI techniques and models can be trained to access ratification templates 508 as references for building out and generating new templates, which can be a form of GenAI. The computer system can iterate through the template generation of block 506 until the templates are populated with relevant information for the ratification and provided back as output to the user device. The relevant user can then view the templates in the GUIs in block 510. The user can provide input to modify or otherwise update one or more of the templates. The user feedback can be provided in a feedback loop back to the computer system as additional inputs to the disclosed AI techniques. The computer system can then iteratively perform block 506 to modify and generate the desired templates for the relevant user. As described herein, the computer system may also iteratively train and improve upon the disclosed AI techniques based on the user feedback.

Once the desired templates are generated in block 510, these templates can be uploaded to an HR system or other enterprise system described herein (block 512). Sometimes, the templates can be uploaded or otherwise transmitted automatically via the data pipeline to the other enterprise system(s) via the computer system.

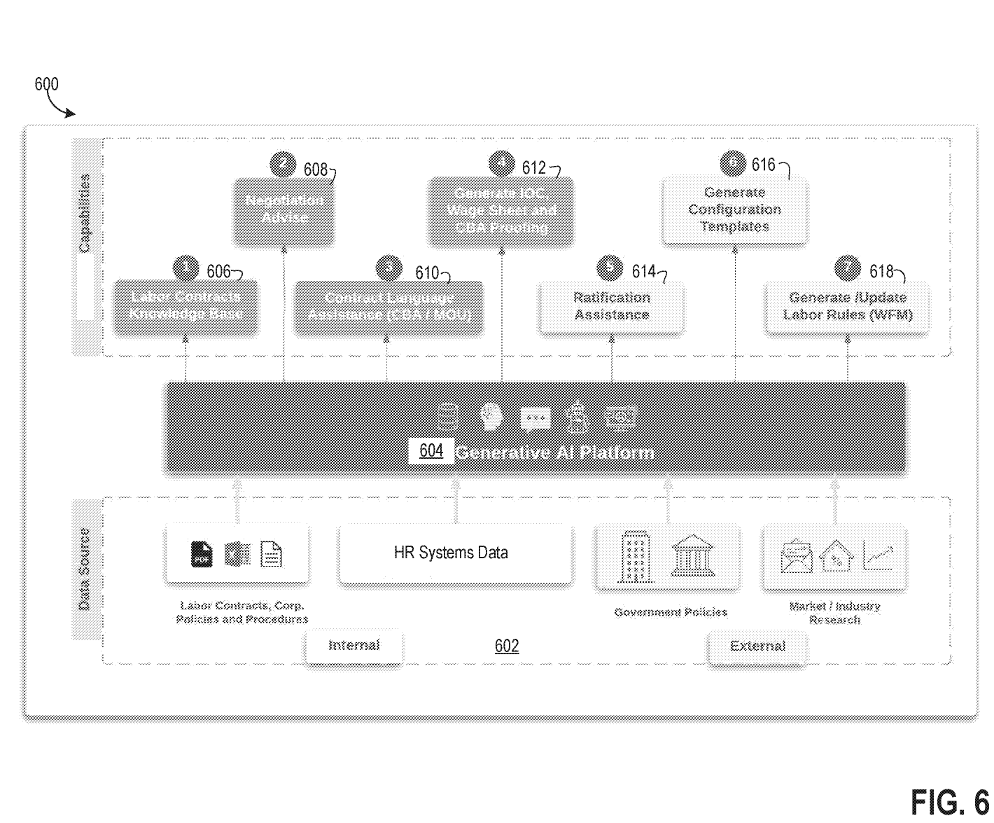

FIG. 6 is a conceptual diagram of a system 600 that can perform operations using the AI techniques described herein. The system 600 can be the same as or similar to the contract ratification system 102 described herein.

The system 600 can include a GenAI platform 604, which can be trained as disclosed, to provide one or more different outcomes and/or capabilities for enterprises during contract negotiations and ratifications. The platform 604 can include one or more AI techniques and/or models. The platform 640 can deliver one or more different capabilities for automation of end-to-end contract ratification processes.

The platform 604 can be configured to receive or otherwise ingest data 602 from a variety of sources to perform the operations. For example, the platform 604 can receive internal data including but not limited to labor contracts, corporate policies, procedures, and/or HR system data. The internal data can include unstructured data, such as internal documents currently being used for labor contract ratifications. Such documents can be used for tuning the disclosed AI techniques and models and getting extracted by the disclosed AI to respond to prompts from relevant users. These prompts can then be used to generate new content, such as templates.

As another example, the platform 604 can receive external data including but not limited to government policies and/or market/industry research. The external data can include structured data for contract ratifications, such as Labor Agreements, Employee Category, Labor Job Code, Job Code by Department, Salary Plan, Salary Steps, Salary Grade, Salary Grade Steps, Scheduled Events, Mapping Tables, Collective agreements, employee category, grade, steps, and ladder, rates and progression of grade, progression rules, schedule events, and/or mapping/lookup tables. Employee demographics and workforce composition, time and attendance, scheduling, performance, cost controls, resource allocation, and/or payroll and benefits admin are among other examples of the external, structured data. Company financial data, which can be external data, can include financial stability, revenue growth, and/or profitability. Profit margins specific to a retail business, sales data, foot traffic, customer demand, and/or market share within a retail industry can also be received as the external data. Additionally or alternatively, government laws and regulations relating to labor standards, minimum wage, overtime pay, youth minimum wage, retail establishment characteristics, notice of proposed rulemaking, etc. may also be received as the external data. Market data such as economic indicators, current economic conditions, inflation rates, and/or GDP growth can be received. Retail sales trends can also be received to gauge industry performance for purposes of contract negotiation. Consumer sentiment data may also be analyzed to monitor consumer confidence and spending patterns. Unemployment rates, job growth/decline, and/or workforce participation rates may be received as the external data as well. Competitor data can also be received as the external data, which can include benchmarking competitor practices against those of the entity, unionization rates and/or strategies amongst competitors, and/or labor negotiations and posture. Sometimes, the external data can include industry data such as reports from industry associations and/or research firms about the state of the industry and/or changes in labor laws and/or regulations relating to the industry.

The platform 604 can be configured to synthesize and process the received data 602 to generate outcomes/capabilities. For example, the platform 604 can generate a knowledge base of labor contracts (block 606). In other words, the disclosed AI techniques can be performed to automatically search, compare, and analyze contracts across divisions, banners, and/or labor unions to provide informative information and recommendations to a negotiating table. The AI techniques can be configured to automatically review a current contract, in some illustrative examples, for labor issues, operating issues, hard dollar items, upload and review other labor contracts in same or similar areas for advantages and disadvantages, review grievances and arbitrations, identify whether any adverse decisions may require change, review past practices to check if contractual, mutual, or unilateral practices may require change, review recent associate survey results and associate comments to identify possible relevant issues, and/or review relevant health and/or pension plans.

As another example, the platform 604 can generate recommendations and advise for negotiating contract changes in block 608. The AI techniques can be used by the platform 604 to analyze the various data 602 of different types and sources to generate comprehensive and data-backed recommendations for countering contract proposals, improving the negotiating process, and achieving desirable outcomes regarding the contract changes.

The platform 604 can generate and/or recommend contract language based on the negotiation, proposals, and/or counters (block 610). The disclosed AI techniques can leverage NLP to process the input data 602, learn context of the data 602 in light of the union proposals, standards, guidelines, and/or business criteria, and generate contract language for new contracts and/or MoUs that can be easily and seamlessly adopted by the relevant stakeholders.

Negotiation advice (block 608) and contract language recommendations (block 610) can be provided to relevant users through the use of a GenAI-powered chatbot as described herein. Accordingly, outputs from one or more of the following actions, which can be performed by the AI techniques, can be provided to the relevant users: generating labor costing models and summaries of said cost models, providing initial proposals based on history, financial data, cost models, market/industry data, and/or based on templates and legal frameworks, generating key points associated with underlying data for negotiation meetings, generating one-page executive summaries and detailed report on the proposal, reviewing union proposed terms, perform data analysis, and providing guidance on the language, and/or discovering potential risks and impacts on operations.

The platform 604 can also generate IOCs, wage sheets, and/or perform CBA proofing in block 612. Block 612 can be performed using the disclosed AI techniques, which can be trained with NLP. These techniques can be trained and implemented to highlight or otherwise identify content from the MoU to the original CBA (e.g., redlining) and/or generate appropriate documentation that can be configured to not only reflect ratified contract changes, but also be seamlessly integrated into existing systems of the enterprise, such as their HR system(s). For example, the AI techniques can also be trained to generate various memos to support communication to union bodies, request extensions if negotiations are expected or predicted to go beyond an expiration date, and/or generate employee communication and/or proposal summaries and key points to review with the relevant users.

The platform 604 can also be deployed to provide ratification assistance in block 614. This can include using the disclosed AI techniques to analyze the IOC and wage sheets, and provide guidance and/or recommendations for contractual changes that may be required or preferred by the ratification. The chatbot can be used by the relevant users to assist in automatically comparing an original contract and MoU with the current ratifications. The chatbot can also be leveraged to answer language-related questions regarding updates to the contract.

The platform 604 can use the disclosed AI techniques to generate configuration templates (block 616). For example, the AI techniques can leverage NLP and be trained to extract data from IOCs and wage sheets, then merge or otherwise integrate the extracted data with data from other systems associated with the enterprise, such as HR systems. By merging or integrating the relevant data, the AI techniques can be configured to automatically generate configuration templates that otherwise would be manually created. As described herein, to process the ratification, the AI techniques may also generate updated or new IOCs, wage sheets, operating manuals, CBA proofs, and/or updates to the original/master contract with the ratified terms from the MoU. With respect to templates, the AI techniques can generate the following templates to ensure that the changed terms and retro pay are appropriately calculated and timely paid: labor agreements, employee category, scheduled events, job codes, facility, valid codes by department, salary step component, grade and wage progression, manage rates, slim mapping, relief, and pay rates, and/or time and pay and absence management. These are merely illustrative templates. One or more other templates may also be generated and/or customized according to a particular use case and/or requirements of the enterprise.

The platform 604 can generate and/or update labor rules and/or other guidance in block 618 using the disclosed AI techniques. For example, the AI techniques can be trained to create or otherwise recommend labor rules according to the CBA, which can relate to time and pay, absence, scheduling, benefits, trust, and/or other aspects corresponding to the CBA. Any existing rules may also be automatically updated based on changes that were requested and/or approved during the ratification process. Sometimes, the relevant users may use the chatbot to upload relevant documents, such as the CBA and/or current procedures. The AI techniques can obtain the data from the users and generate, based on processing the data with NLP, recommendations and/or updates to the existing labor rules and other guidelines in the enterprise.

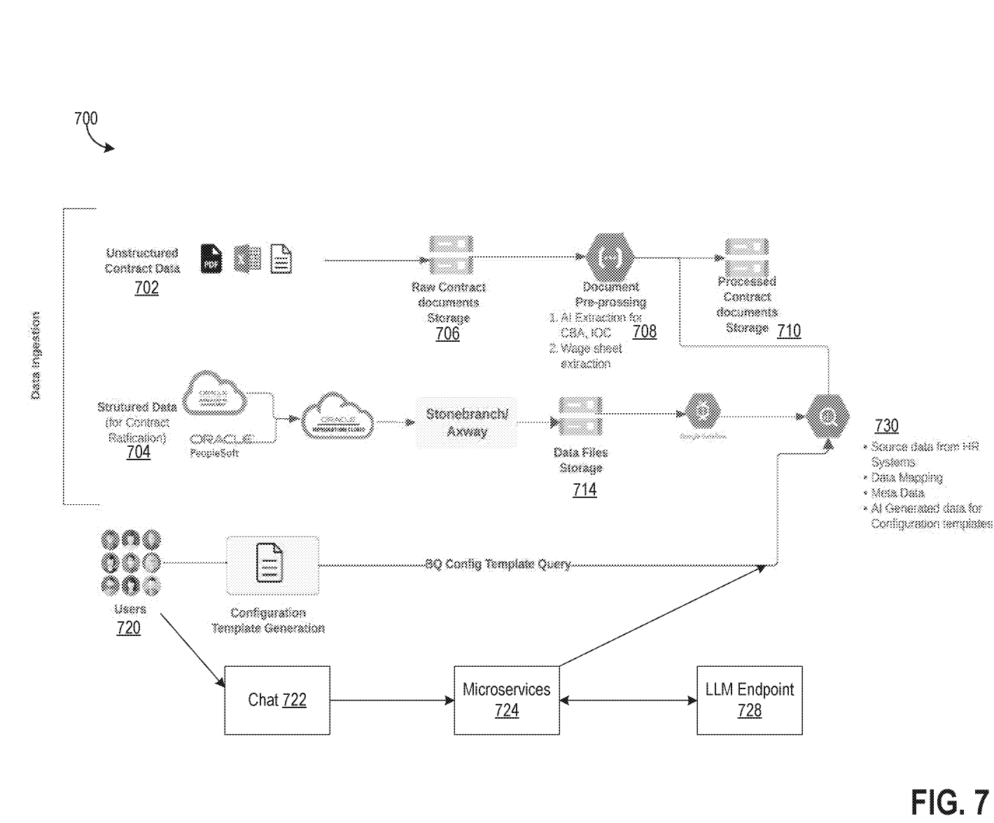

FIG. 7 is a conceptual diagram of a system 700 for performing an AI-enabled contract ratification process. The system 700 can include system components described herein, including but not limited to the contract ratification system 102.

The system 700 can ingest data such as unstructured contract data 702 and/or structured data 704 for contract ratification. Refer to FIG. 6 for further discussion about the data 702 and/or 704. For example, a relevant user can upload documents including but not limited to IOCs with lists of modifying documents wage sheets and/or modified contract terms.

With respect to the unstructured contract data 702, the data 702 can be maintained in raw contract storage 706 before undergoing pre-processing operations 708. The pre-processing operations 708 can include applying optical character recognition (OCR) techniques to extract relevant text from the data 702 and/or splitting up the data 702 into overlapping chunks of data, which advantageously is easier, faster, and more efficient to process through the pipeline described herein. The pre-processing operations can be performed using the disclosed AI techniques that can be trained to pre-process the data 702. The AI techniques can be trained to extract particular types of data, such as contract-related information, vacation-related information, wage-related information, enterprise holidays, etc. Once the data 702 is pre-processed, the resulting pre-processed data can be maintained in processed contract storage 710.

With respect to the structured data 704, the data 704 can be maintained in data files storage 714. The structured data 704 can be retrieved from the storage 714 for purposes of data mapping and/or generating relevant data for a contract negotiation using the disclosed AI techniques.

Still referring to the system 700, relevant users 720 can interact with an AI chatbot 722 by providing inputs such as individual contract queries and/or multiple contracts queries. The AI chatbot 722 can be configured to interface with one or more microservices 724 of the system 700, which can each be configured to leverage the described AI techniques to perform contract comparisons and provide answers or other outputs to the user queries. For example, when the users 720 pose a question about a contract, the user input can be translated, by the system 700, into a prompt and provided to an LLM endpoint 728 for further processing.

The microservices 724 can also communicate with the storages 710 and 714 to perform AI search function 730 to generate/determine information, answers, and outputs to the users queries/questions. The microservices 724 can determine which contract documents may be required and/or which contract data may be relevant based on the user input. Sometimes, the microservices 724 can use natural language SQL and/or RAG patterns and architecture to process the data and generate relevant information based on the user prompt(s). Determinations made by the microservices 724 can then be provided to the LLM endpoint 728 as input, which can be configured to determine, generate, and return outputs or answers to the user’s prompt(s). The LLM endpoint 728 can therefore generate relevant output based on processing the received or retrieved data and other information/prompts provided by the microservices 724. The output can be provided back to the relevant users 720 via the chatbot 722. As an illustrative example, the LLM endpoint 728 can generate templates as output based on contract changes and ratification, which the relevant users 720 can review, update, and/or upload to their respective systems.

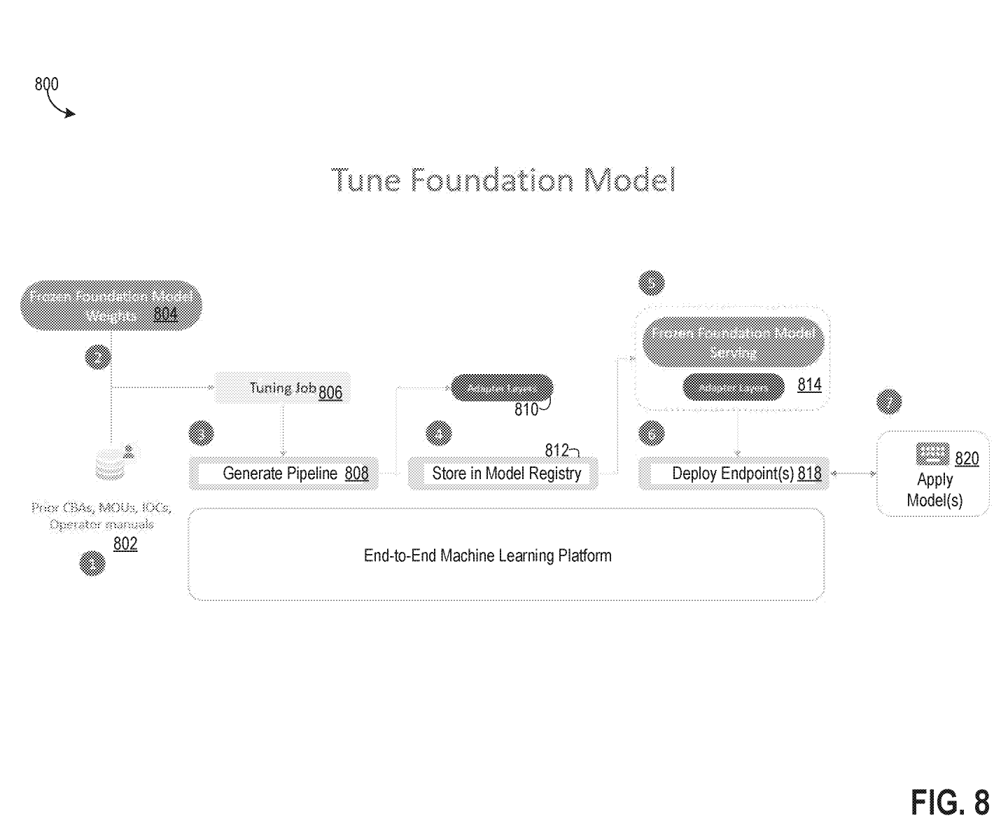

FIG. 8 is a conceptual diagram of a process 800 for training one or more AI models that can be used to perform the disclosed techniques. In some implementations, the model(s) can be trained and finetuned with small amounts of data while providing accurate outputs, which can lead to more efficient use of computational resources, reducing time and power required for training. The process 800 can be a technical improvement over existing model training and finetuning techniques that require large datasets for high accuracy, especially in resource-constrained environments such as edge devices. Similarly, finetuning a pre-trained model on a smaller, domain-specific dataset may result in an improved trade-off between accuracy and the amount of data needed. A technical advantage here includes that the finetuning process 800 allows for improved generalization with a smaller sample size, overcoming data inefficiencies and improving model robustness. Achieving higher accuracy with less data can also be a technical advancement in the field of machine learning. This advantage addresses the challenge of data scarcity, which can be a practical problem in various industries (e.g., labor and retail), and may involve additional techniques to leverage transfer learning, domain adaptation, and/or few-shot learning to achieve higher performance with less data.

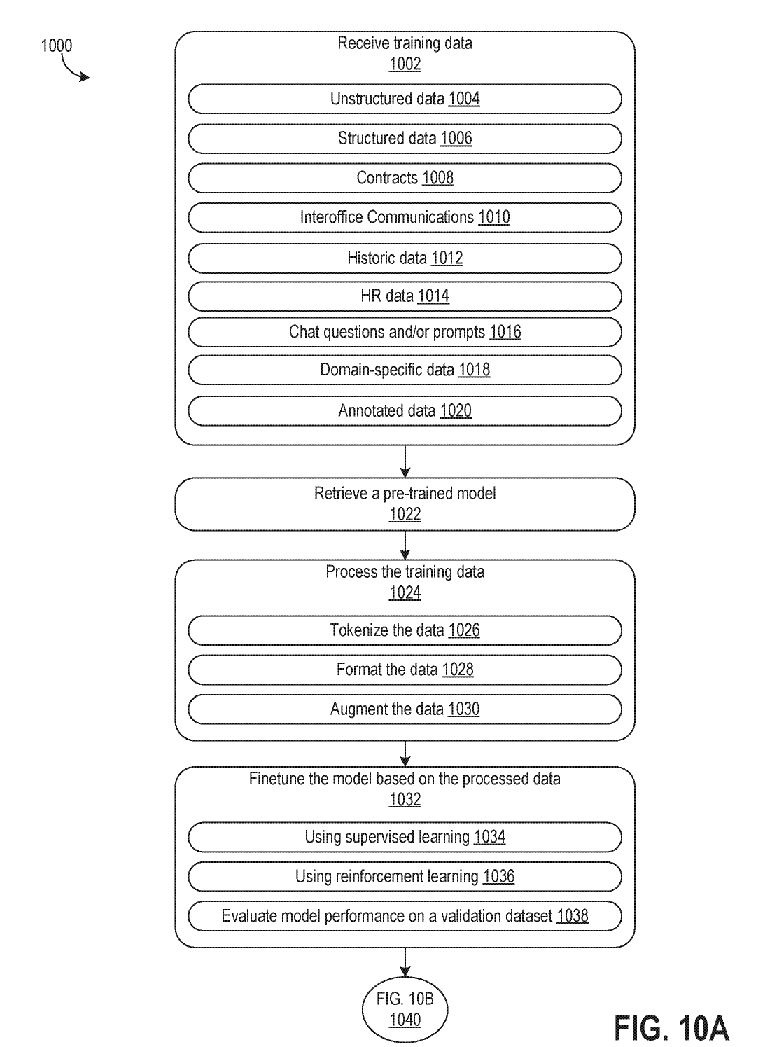

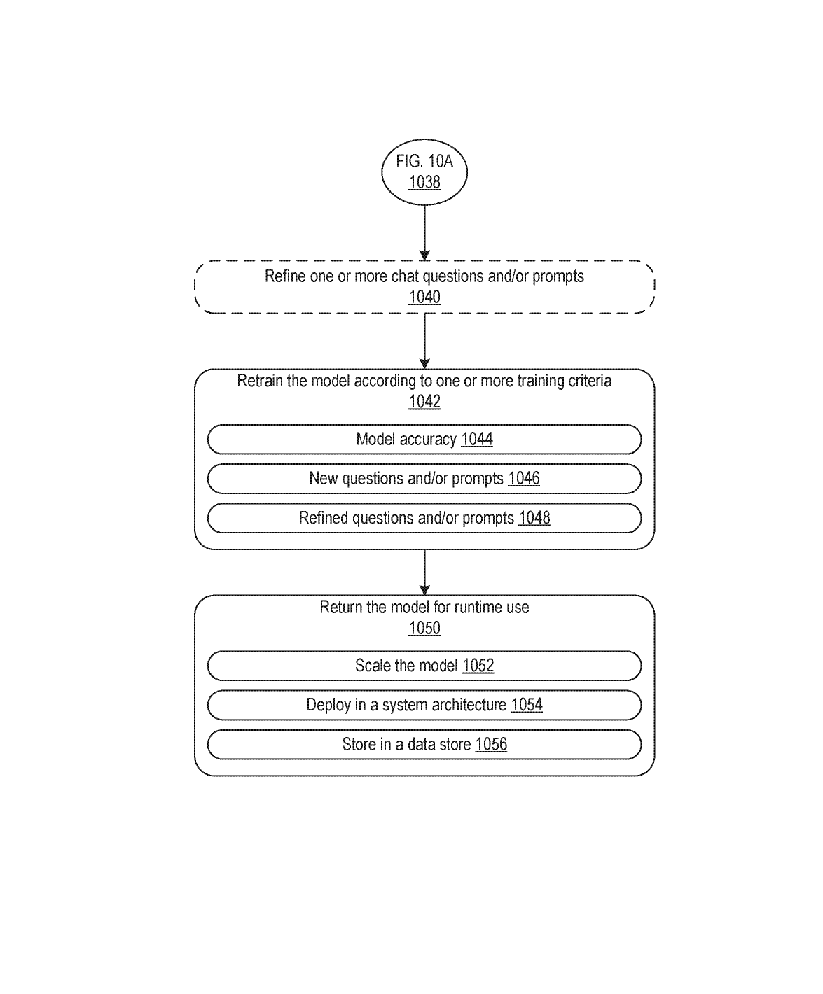

The process 800 can be performed by the contract ratification system 102 or other systems/software modules described herein. For illustrative purposes, the process 800 is described from the perspective of a computer system. Refer to FIGS. 10A and 10B for further discussion about training the AI techniques.

In the process 800, the computer system can retrieve a historical reference of contracts that can be used to tune an LLM foundational model in 802. Other historic data described herein can also be retrieved and used for the training/finetuning of a pretrained model (e.g., LLM). As a result, the historic data can be used to achieve higher accuracy in model outputs and more custom outputs to particular use cases of interest. Other training data can be retrieved, as described with reference to FIGS. 10A and 10B.

In 804, the computer system can retrieve and unfreeze model weights of the LLM foundational model in order to tune a custom model in 806. Pretrained models, such as the LLM foundational model may come in a frozen state, which means their weights are not updated during training. The computer system can implement a line of code, once the LLM foundational model is launched, to unfreeze the weights. In some implementations, the computer system can selectively identify certain layers relevant to the training/finetuning task as unfrozen, while others remain frozen. Once the weights are unfrozen, the computer system can finetune the model based on the training data (e.g., the historic data, predefined prompts).

A pipeline can be generated in 808 to deploy an end-to-end lifecycle of the model’s tuning and deployment. As part of the pipeline, the computer system can tune adapter layers in 810 with custom data (e.g., historic data, labor contract data, business data). The adapter layers can learn specific patterns or domain-specific knowledge (e.g., how to interpret labor contracts) while the pretrained model handles general language understanding. In some implementations, the computer system can add adapter layers to the model then train the adapters while keeping the model parameters frozen. This approach can allow for efficient finetuning without needing to train all the model’s parameters, thereby saving on computation and data requirements. The computer system can manage the finetuning process in block 810 by specifying number of epochs, batch size, learning rate, and/or evaluation strategy. Sometimes, the computer system may freeze some parameters/weights of the model or freeze all the parameters/weights and only train the adapter layers on the custom data.

Tuning with adapter layers can provide additional advantages. For example, instead of finetuning the entire model, the adapter layers can be used to finetune only a small number of parameters of the model, which reduce computational costs and memory usage, thereby improving traditional or existing model training and finetuning techniques. Finetuning adapters can be computationally efficient compared to full model finetuning since the adapter layers introduce fewer parameters into the training and finetuning equation than the entire model. As another example, the adapter layers also allow for switching between different tasks by swapping out adapters, thereby making it easier to transfer knowledge between different domains.

The computer system can store the custom model in a model registry in 812. The model can be stored once the model is finetuned with the adapter layers.

In some implementations, the computer system can apply the adapter layers of the custom model to the frozen foundational model in 814 to generate a custom model endpoint or multiple endpoints. The adapter layers can be used to customize and finetune a foundational model for specific tasks. These layers allow for the model to therefore adapt to new data and requirements without altering a core structure of the foundational model. In the context of tuning a foundational model using the disclosed techniques, the adapter layers can be applied to the frozen foundational model to generate the custom model endpoint. This process can include tuning the adapter layers with custom data and storing a resulting custom model in a model registry or other data storage system.

In other words, the computer system can combine or otherwise integrate the pretrained foundational model (e.g., LLM) with the adapter layers that were trained on the custom data to generate a custom model that can be deployed as an endpoint. Thus, the trained adapter layers can be applied to the foundational model to make the foundational model specialized to particular tasks of interest. The resulting model can therefore process data in the context of the particular tasks of interest and/or use case (e.g., interpreting labor contracts). The endpoint(s) can be a service or interface where a trained model can be deployed and accessed to make predictions. A custom endpoint can serve as an access point where users or applications can send data (e.g., a new labor contract) and receive the model's output (e.g., classification of compliance with terms). In some implementations, different versions of the model can be deployed and/or adapted for multiple use cases. For example, one endpoint can be configured to process labor contract clauses while another can be configured to handle/analyze business data interpretation. This can involve generating and deploying multiple endpoints for different tasks or applications.

Accordingly, the endpoint(s) can be deployed in 818 such that the custom tuned model can be applied or otherwise used in 820.

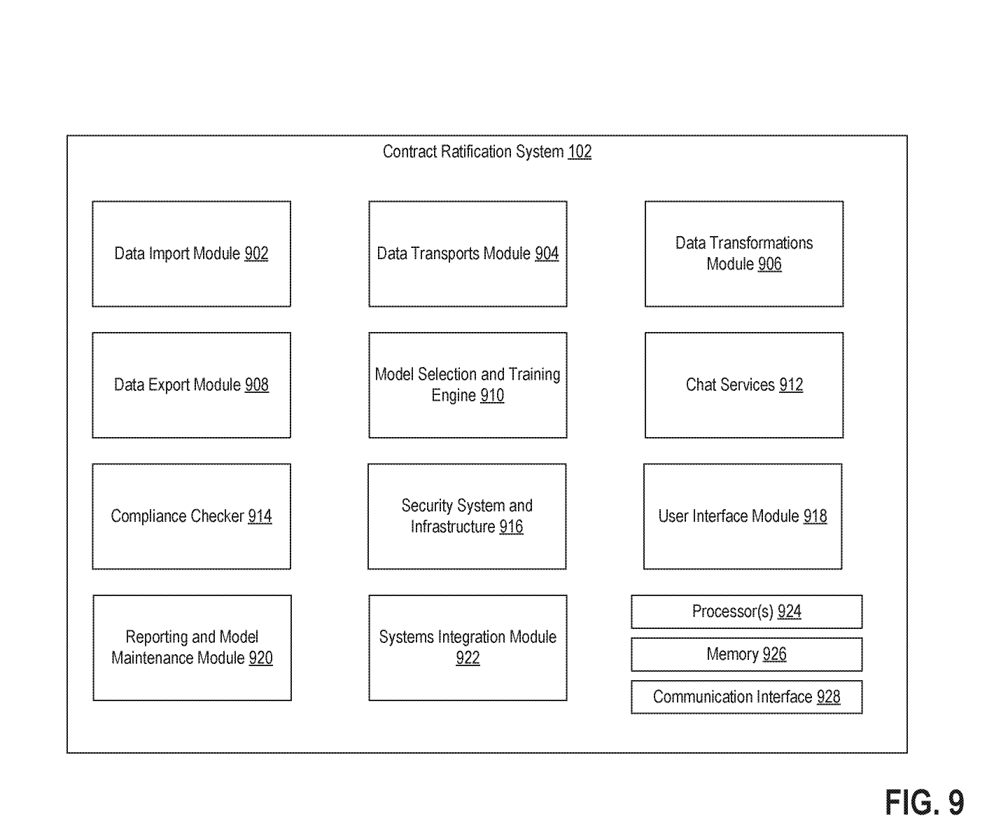

FIG. 9 is a system diagram of components that can be used to perform the disclosed techniques. As a non-limiting example, the contract ratification system 102 can include: a data import module 902, a data transports module 904, a data transformations module 906, a data export module 908, a model selection and training engine 910, a chat services 912, a compliance checker 914, a security system and infrastructure 916, a user interface module 918, a reporting and model maintenance module 920, a systems integration module 922, one or more processors 924, memory 926, a communication interface 928, and/or any combination thereof.

The data import module 902 can be configured to receive, upload, and/or ingest data, such as structured, unstructured, and/or semi-structured data from a variety of data sources described herein. The module 902 can also be configured to retrieve training data that can be used to train/finetune the models described herein.

The data transports module 904 can be configured as a cloud storage or other data store/storage system. The module 904 can be configured to maintain data that is imported via the module 902, including but not limited to raw contract data.

The data transformations module 906 can be configured to perform preprocessing and extraction of the data in the data transports module 904. As described herein, the module 906 can leverage one or more AI models and/or other techniques to perform the preprocessing. For example, the module 906 can clean and/or preprocess the data, including but not limited to tokenization, removing irrelevant information, removing personal data, standardizing formats of the data. Such operations can be performed such that the model(s) can be trained and finetuned using reliable and accurate data.

The data export module 908 can be configured as a cloud storage or other data store/storage system. The module 908 can be configured to maintain the data that was processed/cleaned by the data transformations module 906. The module 908 can also maintain an input criteria that relevant users can provide to customize contracts generated by the contract ratification system. The input criteria can include but are not limited to job title, salary, working hours, benefits, and/or specific clauses for inclusion/exclusion.

The model selection and training engine 910 can be configured to train and finetune the AI techniques/models described herein, using at least data that is maintained by the data export module 908. Refer to at least FIGS. 8, 10A and 10B, for further discussion about training and finetuning the models.

The chat services 912 can be configured to provide a chatbot and corresponding chatbot functionality for deployment at user devices.

The compliance checker 914 can be configured to perform anomaly detection and other compliance analysis. For example, the checker 914 can leverage one or more AI techniques/models to check contracts, proposals, and/or modified contracts against labor rules, guidelines, and/or regulations, which may also be specific to particular jurisdictions and/or industries.

The security system and infrastructure 916 can be configured to provide automated measures for protecting sensitive information relating to users, workers, contracts, and/or an enterprise as a whole. The infrastructure 916 can include encryption techniques, improved access controls, and/or additional techniques for secure data storage.

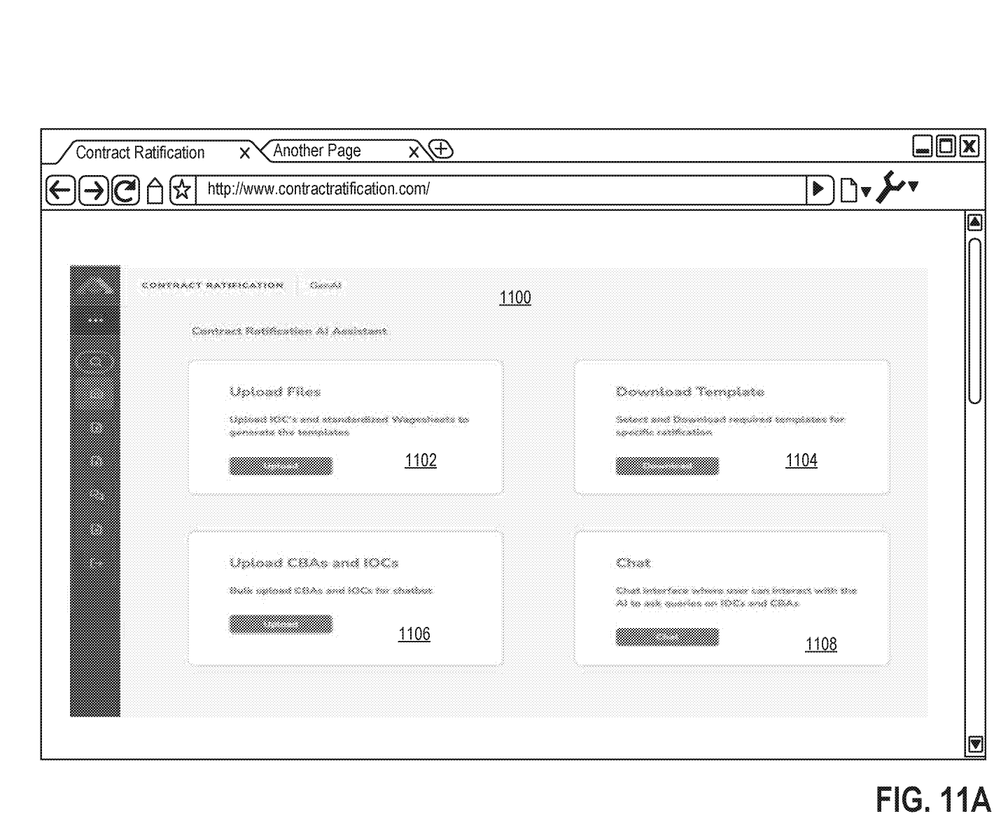

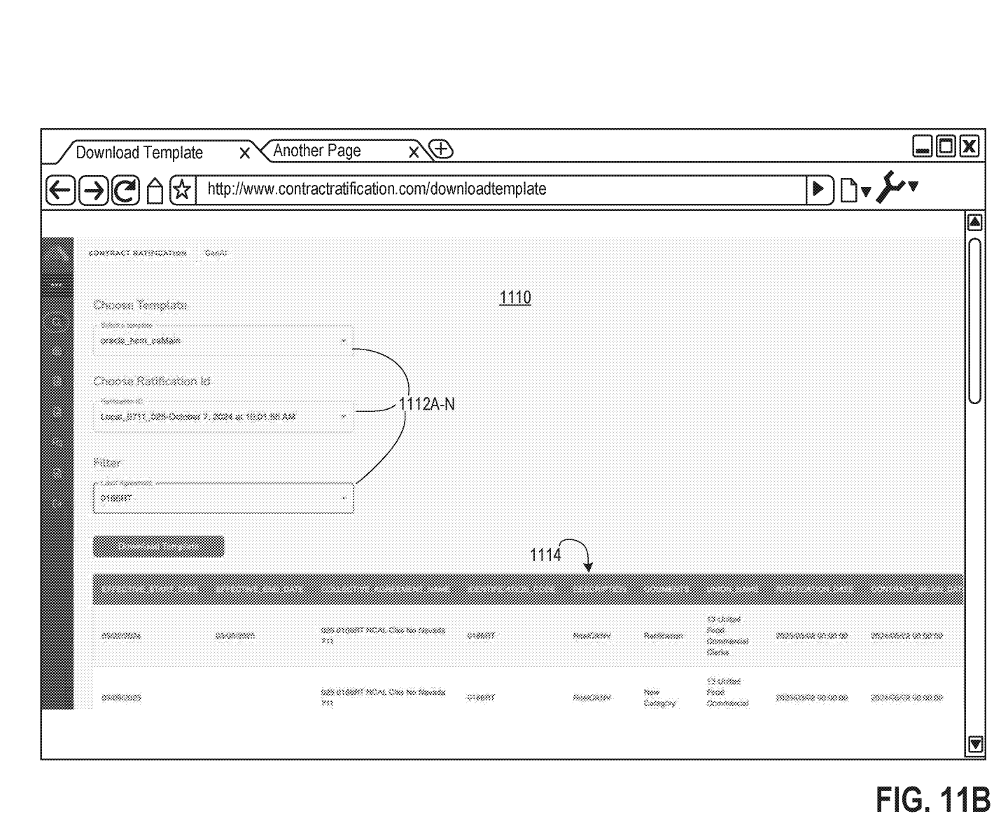

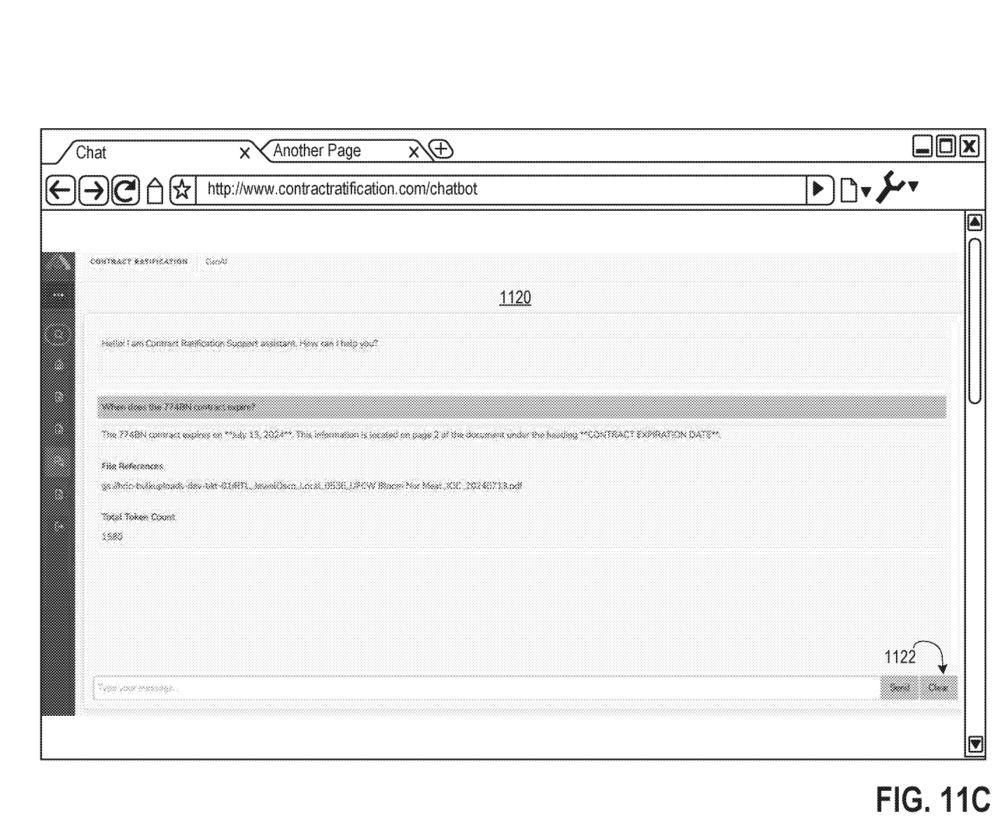

The user interface module 918 can be configured to generate output that can be presented in GUIs at different user devices. Refer to FIGS. 11A, 11B and11C, for further discussion about the GUIs.

The reporting and model maintenance module 920 can be configured to provide a feedback mechanism in the GUIs presented at the user devices. The relevant users can provide feedback based on the outputs from performing the disclosed techniques. Such feedback can be used by the model selection and training engine 910 in order to continuously improve, train, and/or refine the AI techniques/models.

The systems integration module 922 can be configured to provide pipelines, platforms, and engines for seamlessly integrating the contract ratification system 102 with other systems, systems of the enterprise, data stores, third party systems, and/or user systems.

The processor(s) 924 can be configured to execute the tasks and techniques described herein. In some implementations, each of the modules 902, 904, 906, 908, 910, 918, 920, and/or 922 and other services or components of the system 102 can have respective processors. The memory 926 can be configured to maintain instructions that, when executed by the processor(s) 924 uses the contract ratification system 102 to perform the described tasks and techniques. The communication interface 928 can be configured to provide communication (e.g., wired, wireless) between and amongst components of the contract ratification system 102 and/or other systems and devices described herein.

FIGS. 10A and 10B is a flowchart of a process 1000 for training AI models that can be used in a contract ratification process. One or more blocks in the process 1000 can be performed by the contract ratification system 102 described herein. In some implementation, one or more blocks in the process 1000 can be performed by other computing systems, cloud-based systems, and/or software modules. For illustrative purposes, the process 1000 is described from the perspective of a computer system. Refer to FIG. 8 for further discussion about training the models.

Referring to the process 1000 in both FIGS. 10A and 10B, the computer system can receive training data in block 1002. The training data can include but is not limited to unstructured data (block 1004), structured data (block 1006), contracts (block 1008), IOCs (block 1010), historic data (block 1012), HR data (block 1014), chat questions and/or predefined prompts (block 1016), domain-specific data (block 1018), and/or annotated data (block 1020). Sometimes, the computer system can derive the domain-specific data from processing other data, such as the unstructured data, the structured data, the contracts, the IOCs, the historic data, and/or the HR data. The chat questions and/or predefined prompts can be framed such that it causes the model to respond in a desired way (e.g., the prompt tells the AI that it is an HR assistant with expertise in contracts and then provides the AI with sample contract data to analyze).

The computer system can also retrieve a pre-trained model in block 1022. As described herein, the computer system can retrieve a LLM or other similar model for further training and finetuning.

The computer system can process the training data (block 1024). For example, the computer system can tokenize the data in block 1026. Additionally or alternatively, the computer system can format the data in block 1028. Additionally or alternatively, the computer system can augment the data (block 1030). Refer to at least FIGS. 7, 8 and 9, for further discussion about processing the cleaning the training data.

In block 1032, the computer system can finetune the model based on the processed data. The computer system can use supervised learning (block 1034), reinforcement learning (block 1036), and/or any combination thereof. Finetuning LLMs can be accomplished using short prompts, such as zero shot, one shot, few shot, and/or multi show prompting. Sometimes, preprocessed, labeled data can be used to train and finetune the model further.

The computer system can also evaluate model performance based on a validation dataset (block 1038). Accordingly, the computer system can take an existing LLM and finetune it with the predefined prompts. Training through the prompts can allow for teaching the model how to correctly respond to different types of questions that may be received from a user via a chatbot during runtime.

The model can be trained to receive a prompt or question, process the prompt or question to identify a context, identify and retrieve relevant data associated with the context, then process and analyze the retrieve data to generate recommendations or other outputs in response to the prompt or question. As a result, during runtime, a user can provide a question or prompt in the chatbot, which can be provided to the trained model(s). The trained model(s) can be configured to process the user input to retrieve relevant files/data and provide a response to the user’s question or prompt.

The model can be trained with different types of predefined prompts, such as premium rules and relief questions, core contract setup questions, and/or trust rules and company sponsored belief questions. Over time, as more questions are received from users interacting with the chatbot, those questions and be fed back into the computer system to further train and improve the model. Example premium rules and relief questions can include but are not limited to: what premiums are listed in the contract, what is the Sunday premium, what is night or shift premium, what is holiday worked premium, what is the language for full time or part time premiums. Example core contract setup questions can include but are not limited to: what is the effective date of the contract, what is the expiration date of the contract, provide a list of contracts expiring in the next x days, provide net new changes in the IOC/CBA, what is the corresponding pay group, contract ID, contract name, description, union local, and/or contract negotiator associated with this IOC/CBA, is there hired on or after language in the contract and what are the dates, is there hired before language in the contract and what are the dates, are there references to new jobs, and/or what is the language for relief work. Example trust rules and/or company sponsored benefits questions can include but are not limited to: what is the language for 401k, change in eligibility to participate, eligibility for regular company match and/or any unique match formula, and/or are any job codes eligible for company benefits recently.

Optionally, the computer system can refine one or more chat questions and/or prompts (block 1040). The questions and/or prompts can be refined such that they can better frame or direct the model in how to respond when receiving various questions or prompts from a user via the chatbot. In some implementations, the questions and/or prompts can be refined based on actual questions or prompts that are provided by users via the chatbot.

The computer system can retrain the model according to one or more training criteria in block 1042. For example, the computer system can retrain the model based on model accuracy (block 1044). The computer system can continue to train the model until it achieves a desired level of accuracy, such as within a range of 90-100% accuracy. The desired level of accuracy can be adjusted and/or set based on a particular use case and/or industry. The desired level of accuracy can therefore be lower or higher. The computer system can retrain the model based on new questions and/or prompts (block 1046). The new questions and/or prompts can be derived from questions that are asked by users via the chatbot during runtime. The computer system can retrain the model based on refined questions and/or prompts (block 1048), such as the questions and/or prompts that are refined in block 1040.

Once training is complete, the computer system can return the model for runtime use (block 1050). The computer system can scale the model for deployment in block 1052. For example, the model can be scaled such that it can be deployed on the edge, at a user device that launches or otherwise presents GUIs described herein. The computer system can deploy the model in a system architecture in block 1054. Refer to the system architecture of FIG. 9 for further discussion. The computer system can store the model in a data store for future retrieval and runtime use in block 1056.

FIGS. 11A, 11B and 11C, illustrate example GUIs that can be presented at a user device for performing a contract ratification process.

FIG. 11A illustrates a landing page 1100 (e.g., homepage) that can be displayed at the user device. The landing page 1100 can include selectable UI features (e.g., buttons, dropdown menus) that allow the user to navigate to particular functionality of interest. For example, the landing page 1100 can include an upload files module 1102, a download template module 1104, an upload CBAs and IOCs module 1106, and/or a chat module 1108.

The upload files module 1102 can be selected by the user to cause another GUI to be presented in which the user can upload IOCs, standardized wage sheets, and other relevant documents. Such documents can be used by the disclosed computer system to generate templates for the contract ratification process. The user can upload files to a new folder or any existing folders. When creating new folders, the user can designate a bargaining unit and/or a division that the files are associated with. The user may upload IOC documents using standardized naming formats.

The upload CBAs and IOCs module 1106 can be selected by the user to cause another GUI to be presented in which the user can upload/bulk upload CBAs and/or IOCs. The disclosed system can be configured to analyze this uploaded information and compare said information across unions or other divisions.

Refer to FIG. 11B for further discussion about when the user selects the download template module 1104. Refer to FIG. 11C for further discussion about when the user selects the chat module 1108.

FIG. 11B illustrates a download template page 1110, which can be presented in response to the user selecting the download template module 1104 in the landing page 1100 of FIG. 11A. The download template page 1110 can include selectable options 1112A-N. The selectable options 1112A-N can include dropdown menus. One or more other types of selectable elements and features may be used. Using the selectable options 1112A-N, the user can select one or more of templates, ratification identifiers (IDs), agreement filters, and/or any combination thereof. The user inputs can be used by the disclosed technology to identify, generate, and/or present templates in a table 1114 in the download template page 1110.

In some implementations, user input via the selectable options 1112A-N can be used by the disclosed technology to filter records and/or templates that are presented in the table 1114. For example, if the user wants to filter the records based on a specific ratification, they can select a ratification ID followed by an AI-extracted timestamp for the ratification using the selectable options 1112A-N to view latest records based on timestamp in the table 1114. Accordingly, the template information presented in the table 1114 will be specific to the ratification ID and timestamp that the user selected.

FIG. 11C illustrates a chat page 1120, which can be presented in response to the user selecting the chat module 1108 in the landing page 1100 of FIG. 11A. The chat page 1120 can present a chat interface in which the user provides input to interact with the chatbot described herein. For example, the user can provide input including queries on IOCs and/or CBAs. Responses in the chat page 1120 can include answers to the user’s particular queries and/or references to relevant files (e.g., files that were used by the disclosed technology to generate the answers to the queries, files that are relevant to the particular queries, files that the user asks about). The user can continue to ask follow up questions or other subsequent questions in a same cat session if they refer to the same documents/files. The user can also select an option 1122 to clear the conversion in the present chat, which automatically causes a new chat session to begin. In the new chat session, the user can pose questions and other queries relating to a different agreement/contract.

In some implementations, the user can provide input including a particular IOC and/or CBA. Doing so can allow for the disclosed technology to generate and return more accurate and quicker responses to the user, thereby leading to low latency. The user can also provide input including metadata associated with a particular contract or question of interest. The metadata can include but are not limited to union names, IDs, or numbers, contract names, IDs, or numbers, dates of contracts, types of contracts, etc. Providing the metadata in the user’s queries can be beneficial to direct the disclosed technology’s operations and determinations.

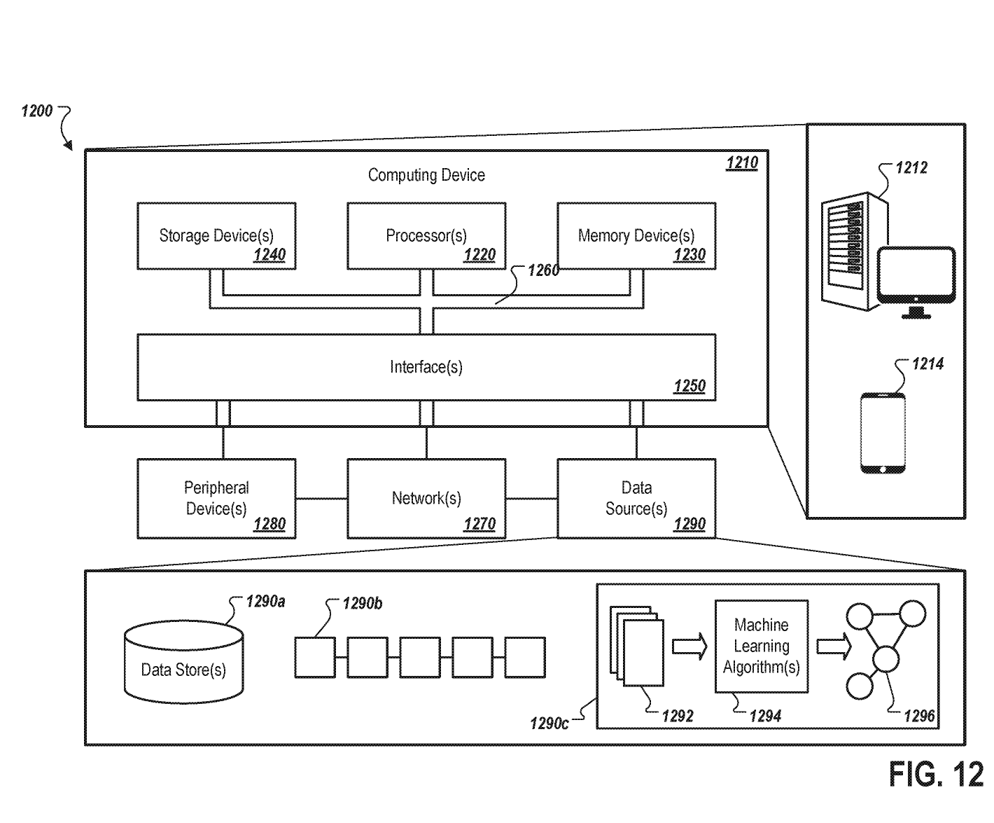

FIG. 12 is a schematic diagram that shows an example of a computing system 1200 that can be used to implement the techniques described herein. The computing system 1200 includes one or more computing devices (e.g., computing device 1210), which can be in wired and/or wireless communication with various peripheral device(s) 1280, data source(s) 1290, and/or other computing devices (e.g., over network(s) 1270). The computing device 1210 can represent various forms of stationary computers 1212 (e.g., workstations, kiosks, servers, mainframes, edge computing devices, quantum computers, etc.) and mobile computers 1214 (e.g., laptops, tablets, mobile phones, personal digital assistants, wearable devices, etc.). In some implementations, the computing device 1210 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1210, and an entire system can be made up of multiple devices communicating with each other. For example, the computing device 1210 can be part of a computing system that includes a network of computing devices, such as a cloud-based computing system, a computing system in an internal network, or a computing system in another sort of shared network. Processors of the computing device (1210) and other computing devices of a computing system can be optimized for different types of operations, secure computing tasks, etc. The components shown herein, and their functions, are meant to be examples, and are not meant to limit implementations of the technology described and/or claimed in this document.

The computing device 1210 includes processor(s) 1220, memory device(s) 1230, storage device(s) 1240, and interface(s) 1250. Each of the processor(s) 1220, the memory device(s) 1230, the storage device(s) 1240, and the interface(s) 1250 are interconnected using a system bus 1260. The processor(s) 1220 are capable of processing instructions for execution within the computing device 1210, and can include one or more single-threaded and/or multi-threaded processors. The processor(s) 1220 are capable of processing instructions stored in the memory device(s) 1230 and/or on the storage device(s) 1240. The memory device(s) 1230 can store data within the computing device 1210, and can include one or more computer-readable media, volatile memory units, and/or non-volatile memory units. The storage device(s) 1240 can provide mass storage for the computing device 1210, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1250 can include various communications interfaces (e.g., USB, Near-Field Communication (NFC), Bluetooth, WiFi, Ethernet, wireless Ethernet, etc.) that can be coupled to the network(s) 1270, peripheral device(s) 1280, and/or data source(s) 1290 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1250 can include a control interface that receives commands from an input device (e.g., operated by a user) and converts the commands for submission to the processors 1220. The interface(s) 1250 can include a display interface that includes circuitry for driving a display to present visual information to a user. The interface(s) 1250 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1270 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1210 can communicate with the peripheral device(s) 1280, the data source(s) 1290, and/or other computing devices over the network(s) 1270. In some implementations, the computing device 1210 can directly communicate with the peripheral device(s) 1280, the data source(s), and/or other computing devices.

The peripheral device(s) 1280 can provide input/output operations for the computing device 1210. Input devices (e.g., keyboards, pointing devices, touchscreens, microphones, cameras, scanners, sensors, etc.) can provide input to the computing device 1210 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1210 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1290 can provide data for use by the computing device 1210, and/or can maintain data that has been generated by the computing device 1210 and/or other devices (e.g., data collected from sensor devices, data aggregated from various different data repositories, etc.). In some implementations, one or more data sources can be hosted by the computing device 1210 (e.g., using the storage device(s) 1240). In some implementations, one or more data sources can be hosted by a different computing device. Data can be provided by the data source(s) 1290 in response to a request for data from the computing device 1210 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1290a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1290b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1290c. The machine learning system(s) 1290c, for example, can be used to analyze data from various sources (e.g., data provided by the computing device 1210, data from the data store(s) 1290a, data from the blockchain(s) 1290b, and/or data from other data sources), to identify patterns in the data, and to draw inferences from the data patterns. In general, training data 1292 can be provided to one or more machine learning algorithms 1294, and the machine learning algorithm(s) can generate a machine learning model 1296. Execution of the machine learning algorithm(s) can be performed by the computing device 1210, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for ratifying a contract, the system comprising:
processors; and
memory storing instructions that, when executed, cause the processors to perform operations comprising:
receiving data about a contract, the data comprising at least a proposal for modifying the contract;
generating contract negotiation information based on processing the data about the contract;
transmitting the contract negotiation information to a user device;
receiving, from the user device, user input responsive to the user device presenting the contract negotiation information;
ratifying one or more contract changes to the contract based on the user input and the contract negotiation information; and
executing instructions to process the ratified contract changes.

2. The system of claim 1, wherein generating the contract negotiation information comprises analyzing, using artificial intelligence (AI), the data about the contract.

3. The system of claim 1, wherein generating the contract negotiation information comprises generating one or more counters to the proposal for modifying the contract based on analyzing (i) the data about the contract and (ii) the contract negotiation information.

4. The system of claim 3, wherein the counters to the proposal for modifying the contract are generated by an AI system that is trained to process and compare historic data about the contract and the proposal for modifying the contract.

5. The system of claim 1, wherein generating the contract negotiation information comprises:
receiving user input about the proposal for modifying the contract in a chatbot presented at the user device;
providing the user input about the proposal for modifying the contract to an AI system, wherein the AI system is trained to generate (i) contract implementation scenarios based on processing the user input about the proposal for modifying the contract and the data about the contract and (ii) cost models based on processing the contract implementation scenarios; and
receiving, as output from the AI system, the contract implementation scenarios and the cost models as the contract negotiation information.

6. The system of claim 5, wherein generating the contract negotiation information further comprises generating, using the AI system, a summary of the proposal for modifying the contract, the contract implementation scenarios, and the cost models.

7. The system of claim 1, wherein the data about the contract is received from a plurality of disparate data sources that are in network communication with the system.

8. The system of claim 1, wherein ratifying the one or more contract changes comprises generating, using an AI system, an inter office communication (IOC) based on the one or more contract changes.

9. The system of claim 1, wherein ratifying the one or more contract changes comprises updating, using an AI system, a wage sheet based on the one or more contract changes.

10. The system of claim 1, wherein ratifying the one or more contract changes comprises:
comparing, using an AI system, the one or more contract changes with existing clauses in the contract; and
generating, using the AI system, a revised version of the contract based on the comparison.

11. The system of claim 1, wherein generating the revised version of the contract comprises redlining, by the AI system, the contract with the one or more contract changes.

12. The system of claim 1, wherein ratifying the one or more contract changes comprises generating, using an AI system, a field operational manual based on the one or more contract changes.

13. The system of claim 1, wherein ratifying the one or more contract changes comprises generating, using an AI system, configuration templates for ratification based on the one or more contract changes.

14. The system of claim 13, wherein the configuration templates comprise pay templates.

15. The system of claim 1, wherein the data about the contract further comprises at least one of an existing labor contract, policies and procedures, HR data, and industry data.

16. The system of claim 1, wherein the generating and the ratifying are performed using an AI system that is automatically deployed at the system.

17. The system of claim 1, wherein transmitting the contract negotiation information to the user device comprises instructions for presenting the contract negotiation information in a chatbot that is presented in a graphical user interface (GUI) at the user device.

18. The system of claim 1, wherein the operations further comprise:
transmitting, to the user device, instructions to cause the user device to present a chatbot in a GUI at the user device;
receiving, responsive to the user device presenting the chatbot in the GUI based on executing the instructions, user input comprising a query;
providing the query as input to an AI system that is trained to generate the contract negotiation information based on processing the input;
receiving, as output from the AI system, a response to the query, wherein the response comprises at least a portion of the contract negotiation information; and
returning, to the user device, second instructions to cause the user device to update the chatbot in the GUI to include the response.

19. The system of claim 18, wherein:
the user input comprising the query further comprises metadata associated with the contract, and the AI system is further configured to:
process the metadata to identify the contract;
retrieve, from one or more data sources, the data about the contract based on identifying the contract; and
generate the response based on processing the user input and the retrieved data about the contract.

20. The system of claim 1, wherein executing the instructions to process the ratified contract changes comprises transmitting the ratified contract changes to a downstream system that is configured to, based on receiving the ratified contract changes, implement the ratified contract changes in an enterprise environment.
